(19) United States
(12) Patent Application Publication
(10) Pub. No.: US 2026/0148873 A1
(43) Pub. Date: May 28, 2026

(54) REACTOR SYSTEMS

(71) Applicant: Nano Nuclear Energy Inc., New York, NY (US)

(72) Inventors: Massimiliano Fratoni, Berkeley, CA (US); Francesco Di Lecce, Milano (IT); Manuele Aufiero, Milano (IT); Peter Hosemann, Berkeley, CA (US)

(73) Assignee: Nano Nuclear Energy Inc., New York, NY (US)

(21) Appl. No.: 19/091,842

(22) Filed: Mar. 27, 2025

Related U.S. Application Data
(60) Provisional application No. 63/570,496, filed on Mar. 27, 2024.
(60) Provisional application No. 63/570,460, filed on Mar. 27, 2024.

(51) Int. Cl. G21D 1/00; F01D 15/10; G21C 1/32

(52) U.S. Cl. CPC G21D 1/00; F01D 15/10; G21C 1/322; F05D 2220/76

(57) ABSTRACT

In some embodiments, a power generation system may include a first nuclear reactor, which may include a vessel having a wall defining a cavity. The nuclear reactor may include a core disposed within said cavity. Said core may include a solid matrix material defining one or more channels. A fuel material may be disposed in said one or more channels. Said solid matrix material may be a primary heat transfer medium. The power generation system may include an electric generating system having a secondary heat transfer medium. The power generation system may include one or more heat exchangers thermally coupled to said vessel wall. Said primary heat transfer medium may transfer heat generated by the fuel material to the one or more heat exchangers. Said secondary heat transfer medium may draw heat from said one or more heat exchangers.

### CROSS-REFERENCE TO RELATED APPLICATIONS

This application claims the benefit of priority under 35 U.S.C. § 119(e) to prior U.S. Provisional Patent Application No. 63/570,496 filed on Mar. 27, 2024 and U.S. Provisional Patent Application No. 63/570,460 filed on Mar. 27, 2024, the disclosures of which are incorporated by reference herein in their entireties.

### FIELD OF DISCLOSURE

The disclosed systems and methods relate to nuclear reactors. More specifically, the disclosure is directed to solid core nuclear reactors and associated systems, devices, and methods.

### BACKGROUND

Nuclear reactors provide significant benefits regarding power generation. A nuclear reactor and associated power plant can replace conventional power stations. Nuclear power plants provide a variety of benefits over conventional power stations, such as less natural resource consumption and cleaner emissions just to give a few examples. However, prior art nuclear power plants are typically very large and expensive to build and maintain. As such, there is a need for smaller, relatively inexpensive nuclear power plants that can be built and shipped to nearly anywhere in the world to support the location's power generation needs.

### SUMMARY

In some embodiments, a power generation system may include a shipping container defining an interior space. The power generation system may include a first nuclear reactor disposed in the interior space proximate one end of the container, said first nuclear reactor comprising a heat-generating fuel material and a primary medium for transferring heat generated by the fuel material to one or more first heat exchangers. The power generation system may include a second nuclear reactor disposed in the interior space proximate the other end of the container. Said second nuclear reactor may include a heat-generating fuel material and a primary medium for transferring heat generated by the fuel material to one or more second heat exchangers. The power generation system may include an electric generating system disposed in the interior space intermediate said first and second nuclear reactors. Said electric generating system may include one or more turbines driven by a fluid. Said turbine may drive fluid absorbing heat from the first and second heat exchangers before driving one or more generators.

In some embodiments, a power generation system may include a first nuclear reactor, which may include a vessel having a wall defining a cavity. The nuclear reactor may include a core disposed within said cavity. Said core may include a solid matrix material defining one or more channels. A fuel material may be disposed in said one or more channels.

Said solid matrix material may be a primary heat transfer medium. The power generation system may include an electric generating system having a secondary heat transfer medium. The power generation system may include one or more heat exchangers thermally coupled to said vessel wall. Said primary heat transfer medium may transfer heat generated by the fuel material to the one or more heat exchangers. Said secondary heat transfer medium may draw heat from said one or more heat exchangers.

### BRIEF DESCRIPTION OF THE DRAWINGS

The features and advantages of the present disclosure will be more fully disclosed in, or rendered obvious by, the following detailed descriptions of example embodiments. The detailed descriptions of the example embodiments are to be considered together with the accompanying drawings wherein like numbers refer to like parts and further wherein:

FIG. 1 illustrates one example of solid core nuclear reactor in accordance with some embodiments;

FIG. 2A illustrates a front view of a vessel of a nuclear reactor in accordance with some embodiments;

FIG. 2B illustrates a plurality of shielding sections disposed within a transportation container in accordance with some embodiments;

FIG. 2C illustrates the vessel of the nuclear reactor disposed within a transportation container in accordance with some embodiments;

FIG. 3 illustrates a cross-sectional view of a nuclear reactor along axis 3-3 shown in FIG. 2A in accordance with some embodiments;

FIG. 4A illustrates a perspective view of a spherical solid core of a nuclear reactor in accordance with some embodiments;

FIG. 4B illustrates a cross-sectional view of the nuclear reactor along axis 4B-4B shown in FIG. 4A. in accordance with some embodiments;

FIG. 5A illustrates a top plan view of one example of a solid core of a nuclear reactor in accordance with some embodiments;

FIG. 5B illustrates a cross-sectional view of the solid core along axis 5B-5B shown in FIG. 5A in accordance with some embodiments;

FIG. 6A illustrates an isometric view of a plurality of fuel elements of a portion of a solid core from detail P shown in FIG. 5A in accordance with some embodiments;

FIG. 6B illustrates a top-down view of a plurality of fuel elements of a portion of a solid core from detail P shown in FIG. 5A in accordance with some embodiments;

FIG. 7 illustrates a cap with a plurality of conductive pins of a fuel element in accordance with some embodiments;

FIG. 8 illustrates a fuel unit of a nuclear reactor in accordance with some embodiments;

FIG. 9 illustrates a top plan view of a solid core with differential fuel enrichment in accordance with some embodiments;

FIG. 10A illustrates a portion of a solid core from detail I shown in FIG. 9 in accordance with some embodiments;

FIG. 10B illustrates a portion of a solid core from detail O shown in FIG. 9 in accordance with some embodiments;

FIG. 11A illustrates a top plan view of a single fuel element of a solid core in accordance with some embodiments;

FIG. 11B illustrates a cross-sectional view of the single fuel element of a solid core along axis 11B-11B shown in FIG. 11A in accordance with some embodiments.

FIG. 12 illustrates a plurality of reinforcing ribs of a vessel in accordance with some embodiments;

FIG. 13A illustrates a top plan view of a nuclear reactor with a reactor control and shutdown system disengaged in accordance with some embodiments;

FIG. 13B illustrates a cross-sectional view of the nuclear reactor along axis 13B-13B shown in FIG. 13A in accordance with some embodiments;

FIG. 14A illustrates a top plan view of a nuclear reactor with a reactor control and shutdown system engaged in accordance with some embodiments;

FIG. 14B illustrates a cross sectional view of a nuclear reactor along axis 14B-14B shown in FIG. 14A in accordance with some embodiments;

FIG. 15A illustrates a top plan view of a nuclear reactor with control rods of a reactor control and shutdown system inserted into a solid core in accordance with some embodiments;

FIG. 15B illustrates a cross-sectional view of a nuclear reactor along axis 15B-15B shown in FIG. 15A in accordance with some embodiments;

FIG. 16A illustrates a top plan view of a nuclear reactor with control rods of a reactor control and shutdown system partially inserted into a solid core in accordance with some embodiments;

FIG. 16B illustrates a cross-sectional view of a nuclear reactor along axis 16B-16B shown in FIG. 16A in accordance with some embodiments;

FIG. 17A illustrates a top plan view of a nuclear reactor with control rods of a reactor control and shutdown system withdrawn from a solid core in accordance with some embodiments;

FIG. 17B illustrates a cross-sectional view of a nuclear reactor along axis 17B-17B shown in FIG. 17A in accordance with some embodiments;

FIG. 18A illustrates a portion of a nuclear reactor in accordance with some embodiments;

FIG. 18B illustrates a detail view of a fuel element bellows in accordance with some embodiments.

FIG. 18C illustrates a detail view of a rod bellows in accordance with some embodiments;

FIG. 19 illustrates one example of a method of transferring heat in a nuclear reactor in accordance with some embodiments;

FIG. 20 illustrates an isometric view of one example of a power generation system in accordance with some embodiments;

FIG. 21 illustrates a side view of one example of a power generation system in accordance with some embodiments;

FIG. 22 illustrates a top view of one example of a power generation system in accordance with some embodiments;

FIG. 23 illustrates aspects of one example of a power generation system in accordance with some embodiments;

FIG. 24 illustrates aspects of one example of a heat exchanger in accordance with some embodiments;

FIG. 25 illustrates aspects of the heat exchanger from detail X shown in FIG. 24 in accordance with some embodiments;

FIG. 26 illustrates a cross-sectional view of a first example of the heat exchanger module using detail Y shown in FIG. 25 in accordance with some embodiments;

FIG. 27 illustrates a top view of an inlet surface of the first example of the heat exchanger module in accordance with some embodiments;

FIG. 28 illustrates a side view of the first example of the heat exchanger module in accordance with some embodiments;

FIG. 29 illustrates an isometric view of the first example of the heat exchanger module from detail Z shown in FIG. 28 in accordance with some embodiments;

FIG. 30 illustrates side views of aspects of a second example of heat exchanger modules in accordance with some embodiments; and

FIG. 31 illustrates a cross-sectional view of aspects of the second example of the heat exchanger module using detail Y shown in FIG. 25 in accordance with some embodiments.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

This description of the exemplary embodiments is intended to be read in connection with the accompanying drawings, which are to be considered part of the entire written description. It should be understood, however, that the present disclosure is not intended to be limited to the particular forms disclosed and that the drawings are not necessarily shown to scale. Rather, the present disclosure covers all modifications, equivalents, and alternatives that fall within the spirit and scope of these exemplary embodiments. In the description, relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected” refer to a relationship wherein structures are secured or attached to one another either directly or indirectly through intervening structures, as well as both movable or rigid attachments or relationships, unless expressly described otherwise. The terms “couple,” “coupled,” “operatively coupled,” “operatively connected,” and the like should be broadly understood to refer to connecting devices or components together either mechanically, or otherwise, such that the connection allows the pertinent devices or components to operate with each other as intended by virtue of that relationship.

The present disclosure includes various embodiments of solid core nuclear reactors that are configured to provide sufficient power generation while maintaining necessary safety controls. The solid core reactors disclosed herein overcome the disadvantages of conventional nuclear reactors and associated power plants, allowing the solid core reactors of the present disclosure to provide sufficient power generation, maintain adequate margins to safety limits, and be configured to be transported anywhere in the world.

The solid core nuclear reactor may not use primary fluid coolant, but the heat may be transferred to the edge of the core by conduction through one or more moderator matrices. This way any risk associated with loss of coolant, loss of flow, boiling, etc., can be eliminated. Without a fluid coolant, all the related components (e.g., pump/blower, pipes, tanks, etc.) and related systems (chemistry and volume control) are eliminated, greatly simplifying the design, and reducing the overall size. Furthermore, the absence of moving systems increases the plant availability and reliability, as well as the nuclear safety, relying only on fully passive components. The secondary system may use an open-air Brayton cycle for converting the thermal energy into electricity, thus eliminating the need for any water supply. According to some embodiments, a power generation system may include two cores and a single compressor-turbine engine.

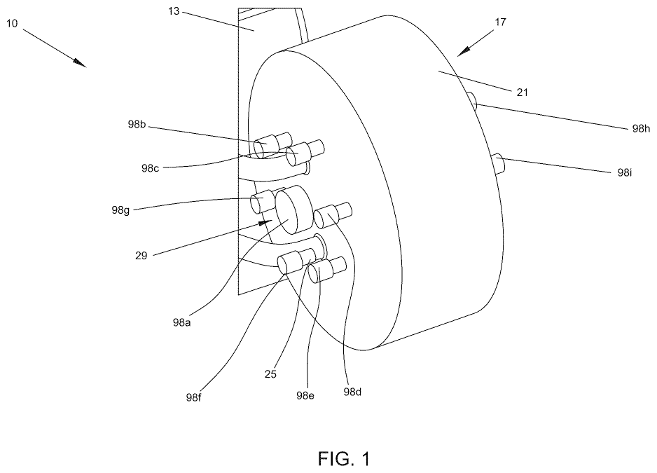

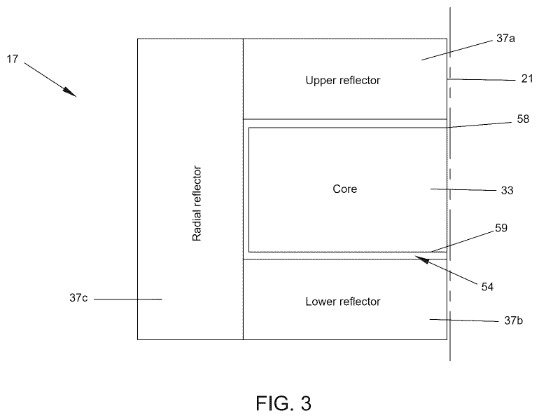

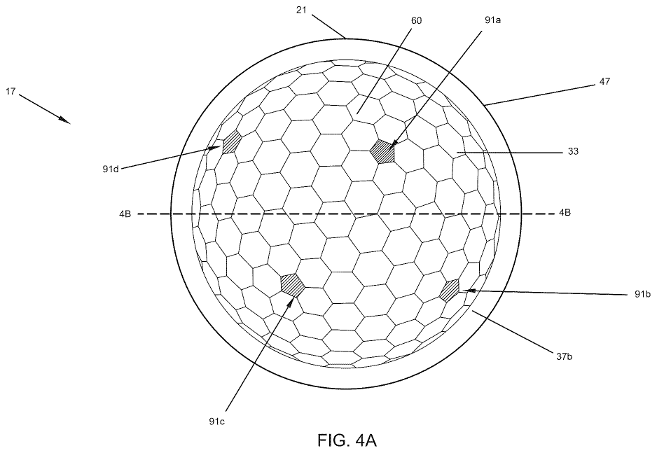

Turning now to the drawings, FIG. 1 illustrates one example of a power generation system 10 in accordance with some embodiments. The heat generation system 10 may include a secondary system 13 and a nuclear reactor 17. The nuclear reactor 17 may include a vessel 21, one or more heat exchangers 25 (e.g., heat transfer unit, thermal transfer unit, etc.), a reactor control shutdown system 29, a solid core 33 as best seen in FIG. 3, and one or more reflectors 37a-c as best seen in FIG. 3. In some embodiments, the one or more heat exchangers 25 may be thermally coupled to the nuclear reactor 17 such that it may transfer heat generated in the nuclear reactor 17 to a secondary medium, such as air, to be used with by a turbine in the secondary system 13 to generate electric power. In some embodiments, the nuclear reactor 17 may provide enough heat for the secondary system 13 to generate 50-1000 kWe of energy.

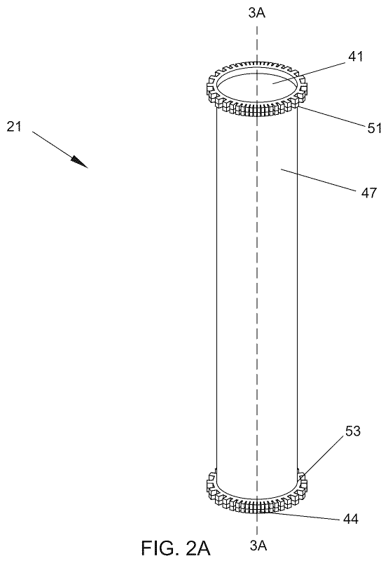

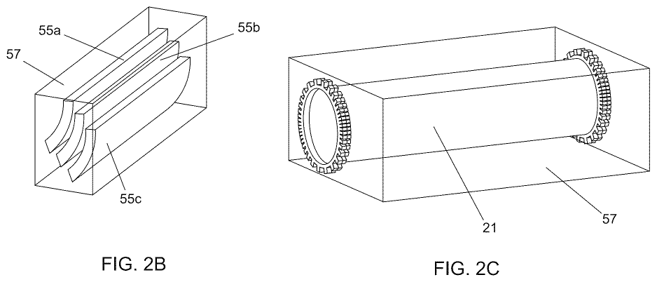

FIG. 2A illustrates a front view of the vessel 21 of the nuclear reactor 17 in accordance with some embodiments. The vessel 21 may have a first end 41, a second end 44, and a wall 47. The wall 47 may extend between a first portion 51 and a second portion 53. The wall 47 may define an interior cavity 54, as best seen in FIG. 3, that extends between the first portion 51 and the second portion 53. In some embodiments, the solid core 33 may be separated from the wall 47 of the vessel 21 with a gas, such as helium or some other suitable gas, disposed in the interior cavity 54.

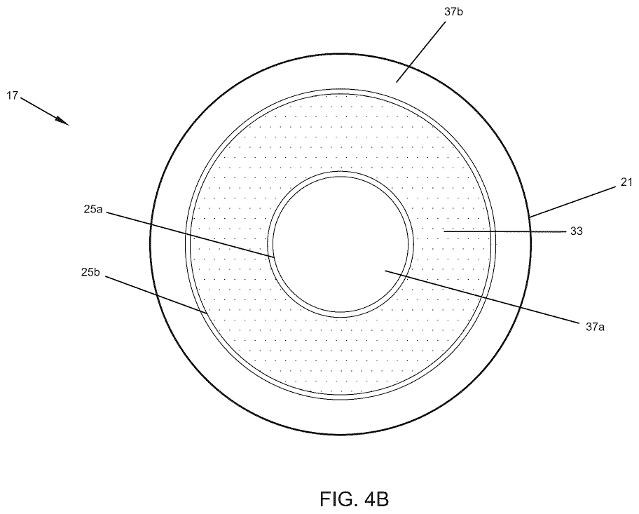

The first portion 51 may be coupled to the first end 41 and the second portion 53 may be coupled to the second end 44 with one or more fasteners, such as bolts. The wall 47 may be any suitable shape. For example, the wall 47 may be generally cylindrical as illustrated in FIGS. 1 and 2A, or generally spherical as best seen in FIG. 4A. It will be appreciated that the shape of the wall 47 may correspond to the shape of the solid core 33 that is disposed within an interior cavity 54 of the vessel 21 (e.g., for embodiments with a spherical solid core 33, the vessel 21 may also be spherical).

The vessel 21 may be made of any suitable nuclear reactor vessel materials, such as a metal or metal alloy. For example, the high temperature and pressure the vessel 21 may experience during shutdown and critical operations may require the vessel 21 to be made of one or more special alloys that have high temperature strength and thermal stability of the crystal lattice. As a first example, the vessel 21 may be made of Alloy 800H-Alloy 800H/AT (“800H/AT”). 800H/AT is an austenitic heat resistant alloy designed for high temperature structural applications. The strength of 800H/AT may be achieved by controlled levels of carbon, aluminum, and titanium included in the alloy.

As a second example, the vessel 21 may be made of Alloy 230-UNS N06230. Alloy 230-UNS N06230 is a nickel-chromium-tungsten-molybdenum alloy that combines high-temperature strength, a resistance to oxidizing environments up to 2100° F. (1149° C.) for prolonged exposures, premier resistance to nitriding environments, and long-term thermal stability. Alloy 230-UNS N06230 may be forged or otherwise hot-worked and castable. Other features of Alloy 230-UNS N06230 may include lower thermal expansion characteristics than most high-temperature alloys and a resistance to grain coarsening with prolonged exposure to high temperatures.

As a third example, the vessel 21 may be made of Alloy 556-UNS R30556. Alloy 556-UNS R30556 is an iron-nickel-chromium-cobalt alloy that may have characteristics such as resistance to sulfurizing, carburizing, and chlorine-bearing environments at high temperatures, oxidation resistance, fabricability, and high-temperature strength. This alloy may have good forming and welding characteristics, and may be forged or otherwise hot-worked. The alloy may also exhibit reasonable retained ductility after long term thermal exposure at intermediate temperatures.

As a fourth example, the vessel 21 may be made of Alloy X-UNS N06002 (W86002). Alloy X-UNS N06002 (W86002) is a nickel-chromium-iron-molybdenum alloy that may have characteristics such as oxidation resistance, fabricability, and high-temperature strength. The alloy may also be resistant to stress corrosion cracking in petrochemical applications. This alloy may have good forming and welding characteristics, and may be forged or otherwise hot-worked.

As a fifth example, the vessel 21 may be made of Alloy 601-Alloy 601. Alloy 601-Alloy 601 may develop a tightly adherent oxide scale, which may resist spalling even under severe thermal cycling. This alloy has good high temperature strength and retains its ductility after long service exposure, with good corrosion resistance under oxidizing conditions.

As a sixth example, the vessel 21 may be made of Stainless Steel 347-S34709 (SS347H). Stainless Steel 347-S34709 (SS347H) may be stabilized by an increased amount of niobium and tantalum, resulting in creep-resistant and high stress rupture properties. The alloy may include enhanced creep resistance and for higher strength at temperatures above 1000° F. (˜538° C.). The non-limiting examples of vessel 21 materials are provided for illustration purposes only. It will be appreciated that other alloys and materials are possible. For example, the vessel 21 may be made of Inconel 617 UNS N06617 according to some embodiments.

FIG. 2B illustrates a plurality of shielding (e.g., lead) sections 55a-c disposed within a transportation container 57 in accordance with some embodiments. FIG. 2C illustrates the vessel 21 of the nuclear reactor 17 disposed within a transportation container 57 in accordance with some embodiments. In some embodiments, the shielding sections 55a-c may be divided into six sectors. When disassembled, the shielding sections 55a-c can be shipped in two 45 ft High Cube containers—three sections 55a-c per container as illustrated in FIG. 2B. The vessel 21 may also be sized such that it also fits within a transportation container 57 as illustrated in FIG. 2C. However, it will be appreciated that the size of components of the power generation system 10 may be scaled such that the entire power generation system 10 may fit within one transportation container 57, such as a 45 ft high cube container (e.g., length 13.716 m, width 2.500 m, height 2.896 m).

FIG. 3 illustrates a cross-sectional view of the nuclear reactor 17 along axis 3-3 shown in FIG. 2A in accordance with some embodiments. As discussed above, the nuclear reactor 17 has a solid core 33 disposed within the interior cavity 54 of the vessel 21. The solid core 33 may extend between a first end 58 and a second end 59. The nuclear reactor 17 may also include one or more reflectors 37a-c also disposed within the vessel 21. For example, in embodiments with a cylindrical wall 47 and solid core 33, the nuclear reactor 17 may include a first reflector 37a disposed adjacent the first end 58 of the solid core 33, a second reflector 37b disposed adjacent the second end 59 of the solid core 33, and a third reflector 37c disposed radially around the solid core 33 as illustrated in FIG. 3.

The reflectors 37a-c may be any suitable reflector material to reflect neutrons back into the solid core 33. For example, Beryllium Oxide (BeO) may be used for the reflector due to its heat transfer and neutron moderation characteristics, which may provide advantages such as minimal core dimension requirements and increased power output. It will be appreciated that other reflector materials may be used, such as steel, steel alloy, inconel, silicon carbide, tungsten carbide, graphite or a carbon allotrope material just to provide a few non-limiting examples. In some embodiments, the radial reflector volume may be approximately 1.25 times that of the solid core 33. In some embodiments, each of the first reflector 37a, the second reflector 37b, and the third reflector 37c are the same material. In some embodiments, the first reflector 37a, the second reflector 37b, and the third reflector 37c are different materials.

FIG. 4A illustrates a perspective view of a spherical solid core 33 of the nuclear reactor 17 and FIG. 4B illustrates a cross-sectional view of the nuclear reactor 17 along axis 4B-4B shown in FIG. 4A. in accordance with some embodiments. In embodiments with a spherical wall 47 and solid core 33, the nuclear reactor 17 may include a first reflector 37a disposed inside the spherical solid core 33 and a second reflector 37b disposed outside and around the spherical solid core 33 as illustrated in FIG. 4B. In some embodiments, the spherical wall 47 and solid core 33 version of the nuclear reactor 17 may include a first heat exchanger 25a between the first reflector 37a and a second heat exchanger 25b between the second reflector 37b and the vessel 21. However, it will be appreciated that the one or more heat exchangers 25 may be disposed external to the vessel 21 no matter the shape of the vessel 21 and solid core 33.

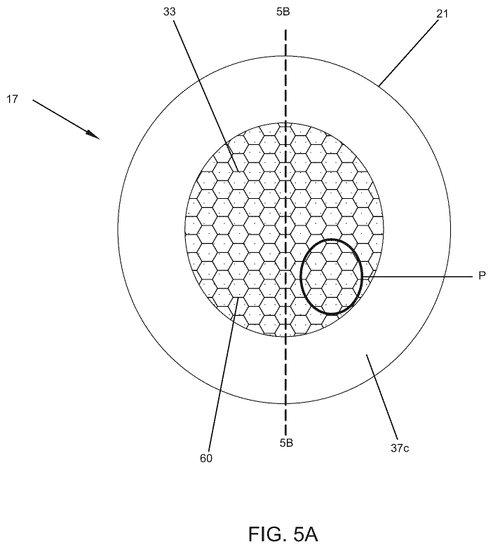

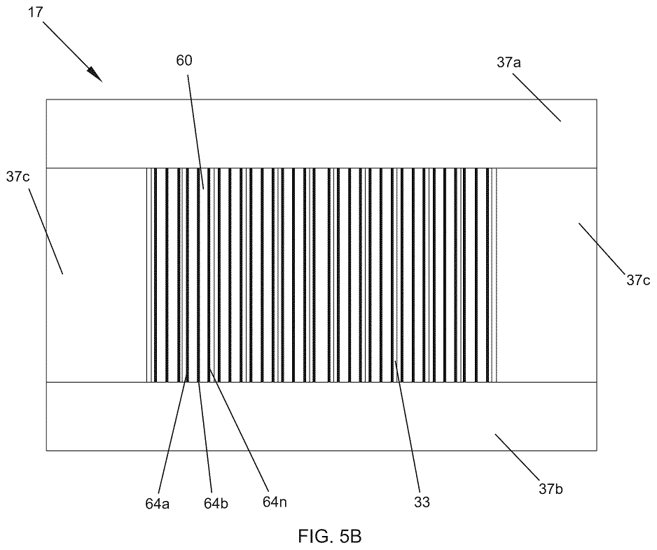

FIG. 5A illustrates a top plan view of one example of a solid core 33 of the nuclear reactor 17 and FIG. 5B illustrates a cross-sectional view of the solid core 33 along axis 5B-5B shown in FIG. 5A in accordance with some embodiments. The solid core 33 may include a plurality of fuel elements 60 that are arranged to form the shape of the core (e.g., arranged to be generally cylindrical or generally spherical) into one or more matrices. As shown in FIG. 5B, each of the fuel elements 60 define one or more channels 64a-c that are sized and configured to receive a heat-generating fuel made of fissionable material. For example, each fuel element 60 may have between 1 and 50 channels 64. The fuel elements 60 may transfer heat from the fuel to the wall 47 of the vessel 21 primarily through conduction and/or irradiation.

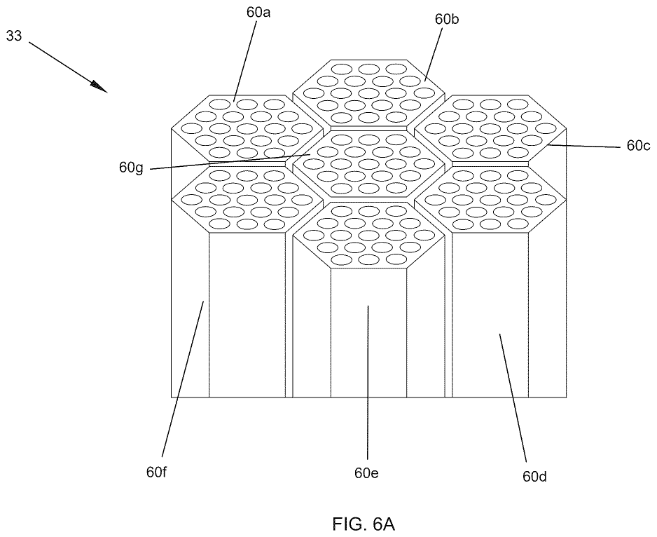

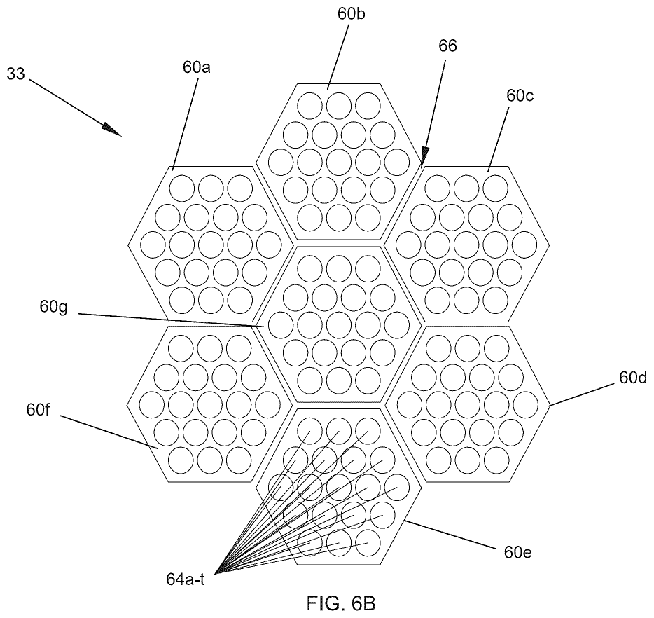

FIGS. 6A-B illustrate isometric and top plan views of a plurality of fuel elements 60a-g of a portion of the solid core 33 from detail P shown in FIG. 5A in accordance with some embodiments. In some embodiments, the fuel elements 60a-g may include one or more of aluminum nitride, beryllium oxide, graphite, synthetic diamond, beryllium carbide, ceramic, or silicon carbide materials. The fuel elements 60a-n may be any suitable shape, such as circular, square, hexagonal, pentagonal, or some other suitable polygonal shape. In some embodiments, the nuclear reactor 17 may operate in a fast neutron spectrum, which may include a uranium nitride (UN) fuel and an aluminum nitride (AIN) fuel element. In some embodiments, the nuclear reactor 17 may operate in a thermal neutron spectrum, which may include a uranium dioxide (UO₂) fuel and a beryllium oxide (BeO) fuel element.

Since the solid core 33 may rely on conduction and/or irradiation as the primary system to transfer heat within the solid core 33, the fuel elements 60a-n may be required to feature high thermal conductivity and structural stability at high temperatures. Aluminum Nitride (AlN) features high thermal conductivity and relatively heavy mass-number components that may be preferred for fast spectrum. Beryllium Oxide (BeO), on the other hand, may be an alternative for the thermal spectrum, although it presents a lower thermal conductivity at very high temperatures. It will be appreciated that other materials (e.g., graphite, synthetic diamond, and beryllium carbide) for thermal and fast neutron spectrums are contemplated.

In some embodiments, fuel element 60 materials may include composite ceramic (e.g., MgO—BeO), graphite, SiC. Regarding the composite ceramics, MgO—BeO may be used for their stability under radiation and good neutronics features. The properties of the mix may depend on the content of BeO. Furthermore, from a neutronics perspective, maximizing the BeO content allows one to benefit from the superior moderating power of beryllium. However, replacing BeO with a mix of MgO and BeO may cause a drop in reactivity for a given solid core 33 size.

Regarding graphite, the effective multiplication factor with a graphite fuel element may be considerably lower than for BeO. A possible solution to increase reactivity would be to consider nuclear reactor 17 configurations with greater height as margins are available if the solid core 33 were to be placed horizontal in the vessel 21. The graphite thermal conductivity may depend on the temperature and on the neutron fluence, but overall, the thermal performance offered by this material may provide for energy between 100-1000 kWe.

In some embodiments, each of the fuel elements 60a-n may be spaced apart by a gap 66, as best seen in FIG. 6B, which may be between 2 and 4 mm in some embodiments, depending on the reactor 17 configuration. The gap 66 may be filled with a liquid metal bond (e.g., liquid lead or sodium) so as to enhance thermal conductivity and reduce fuel peak temperature. In some embodiments, the liquid metal may be 2 mm thick.

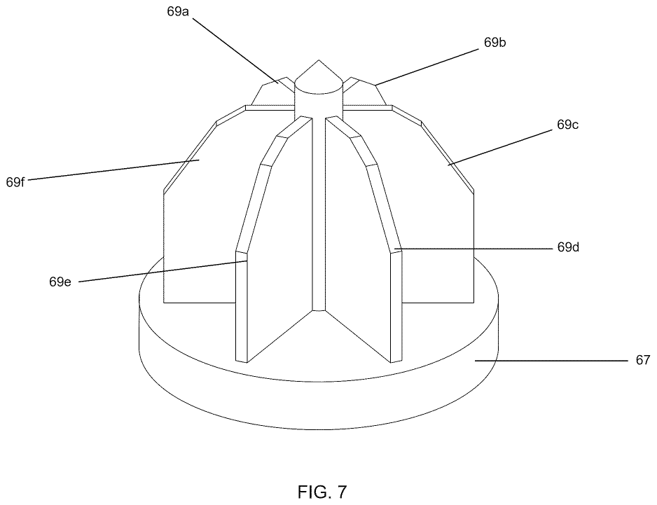

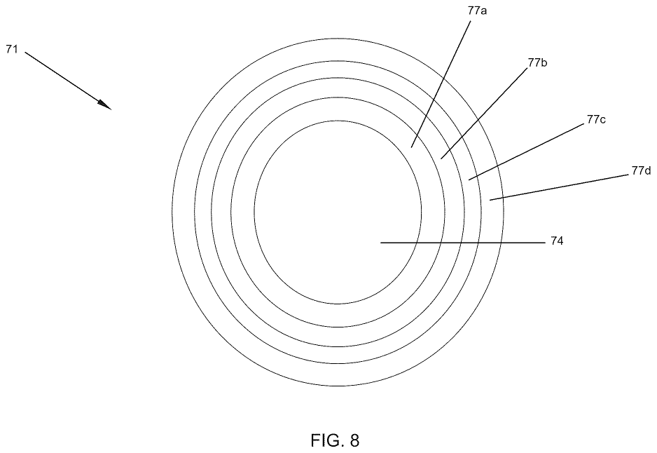

FIG. 7 illustrates a cap 67 with a plurality of conductive pins 69a-f of a fuel element 60 in accordance with some embodiments. A cap 67 may be coupled to the ends of each of the fuel elements 60 (e.g., at first end 58 and second end 59 of the solid core 33) and connected to the vessel wall 47 within the interior cavity 54 of the vessel 21. Such supporting conductive pins 67a-f allow the fuel elements 60a-n of the solid core 33 to freely expand axially, while keeping them in the desired radial position.

In some embodiments, the radius of the fuel channels 64a-n, the pitch between them, the pitch between the fuel elements 60a-n, the gap 66 between fuel elements 60a-n, number of fuel elements 60a-n, and the solid core 33 height may be varied to achieve desired solid core 33 characteristics. For example, thermal and neutronics considerations may change based on the various configurations. In some embodiments, 210 or more different geometries may be used in the nuclear reactor 17 by varying characteristics, such as the core 33 height and diameter for example. In some embodiments, the pitch of the fuel channels 64a-n may be 10-70 millimeters. In some embodiments, the pitch of the fuel channels 64a-n may be at least 10 millimeters but not more than 40 millimeters. In some embodiments, the pitch of the fuel channels 64a-n may be 40 millimeters.

FIG. 8 illustrates a fuel unit 71 of the nuclear reactor 17 in accordance with some embodiments. The fuel unit 71 may include a heat-generating fuel 74 made of fissionable material. The fuel unit may also include one or more outer coatings and/or buffer layers 77a-d. In some embodiments, the outer coatings and/or buffer may include materials such as carbon (C), Pyrolytic Carbon (PyC), and SiC just to provide a few examples. The fuel 74 may include uranium dioxide (UO₂) solid fuel pellets, Uranium Nitride (UN) based fuel pellets, or Uranium Carbide (UC) based fuel pellets. However, it will be appreciated that other fuel materials may be utilized. In some embodiments, uranium enrichment may be set at 19.75 weight%. In the case of the thermal neutron spectrum, the nitrogen in UN may be 99% enriched in N-15, because N-14 has a relatively large neutron absorption cross section. In some embodiments, natural nitrogen may be used for the fast neutron spectrum.

As discussed above, the solid core 33 may include a fuel unit 71 with UN pellet fuel 74 in a AIN fuel element 60. This embodiment may leverage the fast neutron spectrum, allowing it to operate with a minimum excess reactivity that remains approximately constant through the core lifetime. This embodiment may not need burnable poison. At the same time reactivity control and power flattening might be more challenging due to reduced effectiveness of the control rods and smaller magnitude of reactivity feedbacks.

In some embodiments, a solid core 33 may have a fuel unit 71 that includes UO₂ pellet fuel 74 in a BeO fuel element 60. This embodiment may leverage the thermal spectrum, which may allow for a much smaller amount of fuel 74 required to meet the neutronics constraints. However, the beginning of life solid core 33 may have high excess reactivity that may need to be managed using burnable poisons.

In some embodiments, the solid cores 33 as discussed herein may include fuel units 71, such as Tri-structural isotropic (TRISO) particles or those with ceramic fuel particles (e.g., CERMET fuels). TRISO particles may be in the form of pellets (e.g., fully ceramic microencapsulated (FCM) fuel). For CERMET fuels, both oxide and nitride fuel 74 in a tungsten metal fuel element 60 may be used. In embodiments where the volume of the fuel 74 is limited, CERMET fuels may be viable using high density fuel 74, e.g., UN. As CERMET fuel is capable of withstanding very high temperatures, this option can achieve a higher electrical power output (e.g., up to 1000 kWe in some embodiments).

TRISO particle fuel 74 is a robust form of fuel capable of operating at high temperature and high burnup conditions. TRISO particles may include a spherical fuel kernel (less than 0.5 mm diameter in some embodiments) coated with one or more thin layers (e.g., any one of layers 77a-d), such as layers of high-density carbon and silicon carbide (SiC). These layers function as a miniature pressure vessel capable of retaining fission products. The fuel units 71 are then embedded in a fuel element 60 to create fuel elements of the desired shape. For example, in FCM form, TRISO particles are embedded in a fuel element 60 to form fuel units 71 that are then piled in the channels 64a-n of each of the fuel elements 60a-n. For example, the fuel units 71 may be placed in the plurality of channels 64a-n of each of the fuel elements 60a-n, which may behave as both neutron moderator and conductive fuel element 60 to transfer heat towards the wall 47 of the vessel 21. In some embodiments, the fuel units 71 may be directly assembled within the fuel elements 60a-n and separated from the respective fuel element 60 by a liner coating to prevent fission product diffusion into the fuel element 60. In some embodiments, the liner may be tungsten (W).

CERMET fuel is a type of dispersion fuel that may include ceramic particles of fuel dispersed in a fuel element 60 of a certain metal. The ceramic material, which may include UO₂ or UN, provides a stable fuel element 60 to hold the fuel units 71 in place, whereas the metallic material, which may be tungsten or molybdenum, provides a high thermal conductivity to help dissipate heat. Two such examples of CERMET fuel are Tungsten-Uranium Nitride (W—UN) and Tungsten-Uranium Dixide (W—UO₂).

As far as the geometrical configuration of the solid core 33 is concerned, the design with CERMET fuel may still use fuel elements 60a-n, but each of the fuel elements 60a-n may not include channels 64a-n with fuel units 71 disposed therein as the fuel units 71 are dispersed throughout each of the fuel elements 60a-n. As mentioned, a major feature of CERMET fuel is the possibility to operate at very high temperatures, such as 2200° C. or more for example.

In some embodiments, the nuclear reactor 17 may operate with a fast neutron spectrum and have UO₂ fuel 74, AIN fuel elements 60a-n, liquid lead disposed in a 0.5 mm gap 66, and one or more BeO reflectors 37a-c that are 50 cm thick. The electric output for this nuclear reactor 17 may be 100-1000 kWe.

In some embodiments, the nuclear reactor 17 may operate with a fast neutron spectrum and have UN fuel 74, AIN fuel elements 60a-n, liquid lead disposed in a 0.5 mm gap 66, and one or more BeO reflectors 37a-c that are 50 cm thick. The electric output for this nuclear reactor 17 may be 100-1000 kWe. From the thermal point of view, even though UN has higher thermal conductivity than UO−₂, the center fuel unit 71 temperatures do not vary considerably when compared with the previously mentioned nuclear reactor 17.

In some embodiments, the nuclear reactor 17 may operate with a thermal neutron spectrum and have UN fuel 74, which may be enriched in N-15, BeO fuel elements 60a-n, helium disposed in a 0.2 mm gap 66, and one or more BeO reflectors 37a-c that are 50 cm thick. To obtain a thermal spectrum, the fuel elements 60a-n may be enlarged and the fuel element 60 to fuel 74 volume ratio may be increased. The thermal neutron spectrum may enable a much larger neutron multiplication factor, and the use of UN fuel 74 may maintain the core dimensions within the acceptable dimensional limits to facilitate transportability. The electric output for this nuclear reactor 17 may be 100-1000 kWe.

In some embodiments, the nuclear reactor 17 may operate with a thermal neutron spectrum and have UO₂ fuel, BeO fuel elements 60a-n, helium disposed in a 0.2 mm gap 66, and one or more BeO reflectors 37a-c that are 50 cm thick. Compared to UN, UO₂ would not require enrichment of N, but may contain less uranium per fuel unit 71 volume. UO₂ thermal conductivity may be limited, therefore, in order to limit peak fuel 74 temperatures, the fuel units 71 may be a cylindrical wall shape with a center hole, which may be 0.5 mm. The electric output for this nuclear reactor 17 may be 100-1000 kWe. It will be appreciated that these nuclear reactors 17 are provided for illustration only and may include one or more changes to size, shape, materials, etc.

Although some embodiments of the solid core 33 have a uniform core composition, other solid core 33 compositions are contemplated. For example, burnable poisons may be used based on excess reactivity considerations. In some embodiments, however, differential fuel 74 enrichment may be used to flatten the power distribution of the nuclear reactor 17 and, simultaneously, to limit excess reactivity over the nuclear reactor 17 lifetime.

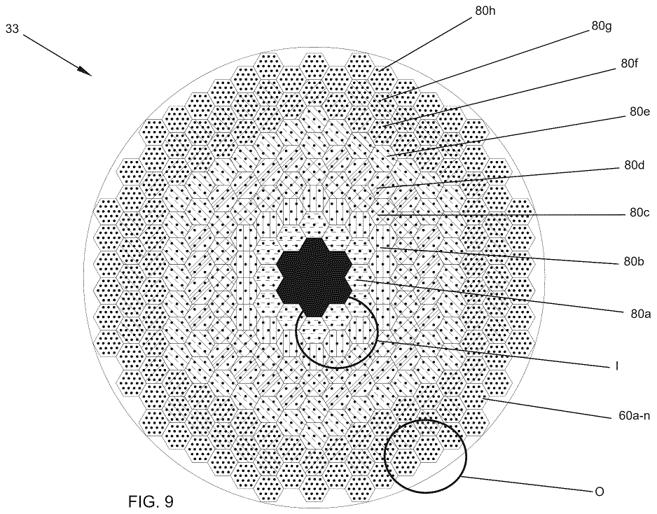

FIG. 9 illustrates a top plan view of a solid core 33 with differential fuel 74 enrichment in accordance with some embodiments. The reactor core 33 may include one or more zones 80a-h (i.e., the rings of fuel elements 60a-n around the solid core 33) with different levels of fuel 74 enrichment, levels of burnable poisons, or a combination thereof. Although eight zones 80a-h are shown in FIG. 9, it will be appreciated that there may be more or less than eight different zones 80a-h.

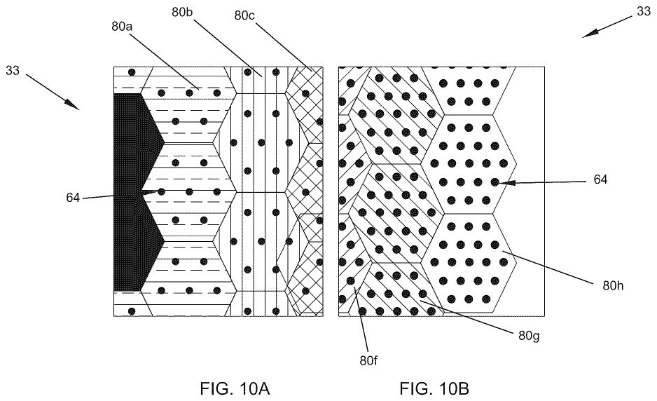

FIG. 10A illustrates a portion of the solid core 33 from detail I shown in FIG. 9 and FIG. 10B illustrates a portion of the solid core 33 from detail O shown in FIG. 9 in accordance with some embodiments. In some embodiments, the zones 80a-h may have higher levels of enrichment in the outer rings (i.e., away from the center of the solid core 33) and lower levels of enrichment in the inner rings (i.e., towards the center of the solid core 33). For example, the fuel elements 60a-n of one or more of the inner zones 80a-e may have less channels 64a-n than one or more of the outer zones 80f-h as illustrated in FIGS. 10A-10B. In some embodiments, the fuel elements 60a-n of one or more inner zones 80a-c may have seven channels 64a-g and the fuel elements 60a-n of one or more outer zones 80f-h may have nineteen channels 64a-s. It will be appreciated that the fuel elements 60a-n of the solid core 33 may have any suitable number of channels 64a-n, which may be less than seven, between seven and nineteen, or more than nineteen.

Although fuel 74 enrichment has been discussed as being differentially dispersed in one or more zones 80a-h, it will be appreciated that differential fuel 74 enrichment may also include differing values of fuel 74 enrichment along the channels 64 of each of the fuel elements 60a-n. Meaning the fuel 74 enrichment may differ axially within each channel 64 of a respective fuel element 60 from the first end 58 of the solid core 33 to the second end 59 of the solid core 33. In some embodiments, the length of the fuel channels 64 within the fuel elements 60 may vary. For example, in a spherical core 33 embodiment, the length of the fuel channels 64 may not extend all the way to the center of the spherical core 33 (i.e., some channels 64 may be shorter than others).

In some embodiments, burnable poisons dispersed through the solid core 33 may be used to flatten the reactivity and fuel burnup. Neutron absorber materials for the burnable poison may include Gadolinium (Gd) and Erbium (Er) oxides that are dispersed in the fuel unit 71. Even though the content of Gd oxide needed to get criticality at beginning of life (BOL) is relatively small, the gadolinium depletion may be excessively rapid to ensure long-term controllability of the solid core 33. The enrichment distribution may be used to flatten the power distribution of the solid core 33: (1) radially-for lowering the radial power peaking factor; and (2) axially—for reducing the axial temperature peaking factor.

In some embodiments, erbium oxide (Er₂O₃) may be used as a poison instead. With a uniform value of enrichment of 12.5%, for example, the volume percentage of Er₂O₃ to get BOL criticality may be 0.86 vol%, which is larger than 0.265% needed if Gd is used. However, erbium oxide may be a better candidate as far as burnup flattening is concerned. Adopting the differential fuel enrichment axial zones 80a-h described above, different uniform concentrations of Er₂O₃ may be used in order to flatten the evolution of the effective multiplication factor over the solid core 33 in time. Any remaining reactivity excess may be handled during normal operations, such as through control rod insertions/withdrawals as discussed in more detail below.

IFBA fuel may be another alternative to dispersed burnable poisons. IFBA uses an outer coating applied on the fuel units 71, similar to some pressurized water reactors (PWRs). This technology may use UO₂ fuel units 71 coated by a thin layer of Zirconium diboride (ZrB₂) (e.g., one of the layers 77a-d). In some embodiments, the thickness of the absorber coating and the differential fuel enrichments zones 80a-h may affect the Keff flattening.

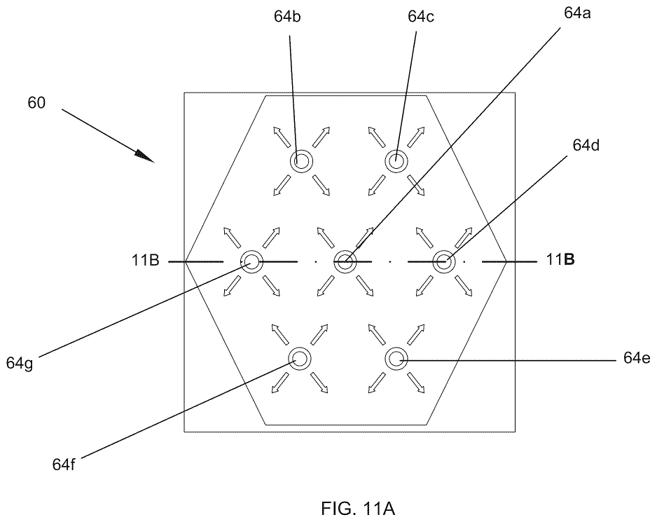

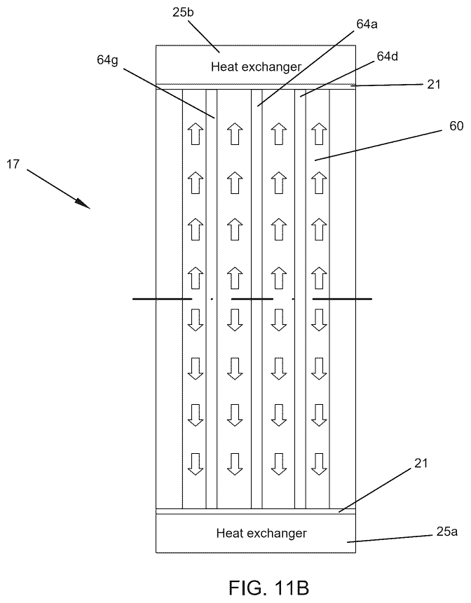

FIG. 11A illustrates a top plan view of a single fuel element 60 of a solid core 33 in accordance with some embodiments. FIG. 11B illustrates a cross-sectional view of the single fuel element 60 of the solid core 33 along axis 11B-11B shown in FIG. 11A in accordance with some embodiments. From the thermal point view, heat may be transferred by conduction and/or irradiation to the secondary system 13 through each of the fuel elements 60. As best seen in FIG. 11A, heat may be produced in the fuel units 71 disposed in the fuel channels 64a-g, which may be transferred radially to the fuel element 60. The heat may then be dissipated towards the vessel 21 (e.g., the wall 47 of the vessel 21) and eventually to the one or more heat exchangers 25a-b as best seen in FIG. 11B.

In some embodiments, the 20-100 percent of the heat generated in the solid core 33 is transferred to the one or more heat exchangers 25 by conduction and/or irradiation. In some embodiments, at least 50 percent of heat transferred by the solid core 33 through the primary medium (e.g., fuel 74 to fuel element 60 to vessel wall 47) to the one or more heat exchangers 25 may be by conduction and/or irradiation. In some embodiments, at least 55 percent of heat transferred by the solid core 33 through the primary medium to the one or more heat exchangers 25 may be by conduction and/or irradiation. In some embodiments, at least 60 percent of heat transferred by the solid core 33 through the primary medium to the one or more heat exchangers 25 may be by conduction and/or irradiation. In some embodiments, at least 65 percent of heat transferred by the solid core 33 through the primary medium to the one or more heat exchangers 25 may be by conduction and/or irradiation. In some embodiments, at least 70 percent of heat transferred by the solid core 33 through the primary medium to the one or more heat exchangers 25 may be by conduction and/or irradiation. In some embodiments, at least 75 percent of heat transferred by the solid core 33 through the primary medium to the one or more heat exchangers 25 may be by conduction and/or irradiation. In some embodiments, at least 80 percent of heat transferred by the solid core 33 through the primary medium to the one or more heat exchangers 25 may be by conduction and/or irradiation. In some embodiments, at least 85 percent of heat transferred by the solid core 33 through the primary medium to the one or more heat exchangers 25 may be by conduction and/or irradiation. In some embodiments, at least 90 percent of heat transferred by the solid core 33 through the primary medium to the one or more heat exchangers 25 may be by conduction and/or irradiation. In some embodiments, at least 95 percent of heat transferred by the solid core 33 through the primary medium (e.g., fuel 74 to fuel element 60 to vessel wall 47) to the one or more heat exchangers 25 may be by conduction and/or irradiation. In some embodiments, at least 100 percent of heat transferred by the solid core 33 through the primary medium to the one or more heat exchangers 25 may be by conduction and/or irradiation.

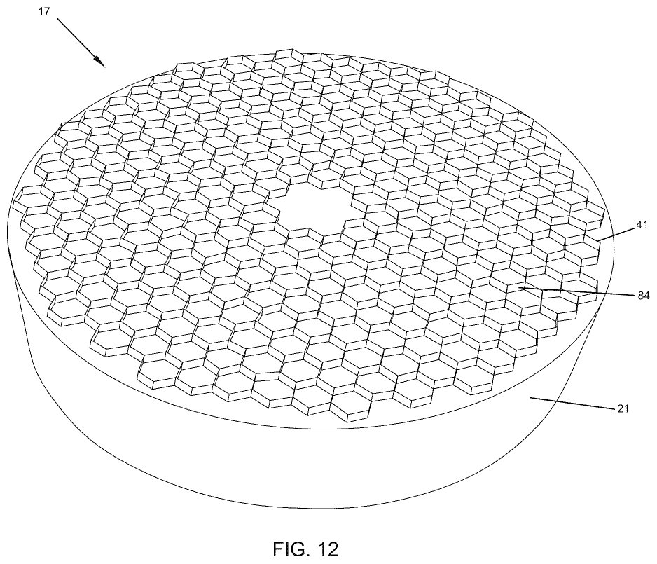

FIG. 12 illustrates a plurality of reinforcing ribs 84 of the vessel 21 in accordance with some embodiments. Since the first end 41 and the second end 44 of the vessel 21 may be thin, the first end 41 and/or the second end 44 of the vessel 21 may include a plurality of reinforcing ribs 84. The reinforcing ribs 84 may be any suitable shape, such as square, hexagonal, pentagonal, or some other polygonal shape. In some embodiments, the shape of the reinforcing ribs 84 may correlate to the shape of the plurality of fuel elements 60a-n disposed within the solid core 33 of the vessel 21. As such, a heat exchanger 25 placed among the reinforcing ribs 84 on the outside of the vessel 21 will be directly over the corresponding plurality of fuel elements 60a-n within the vessel 21.

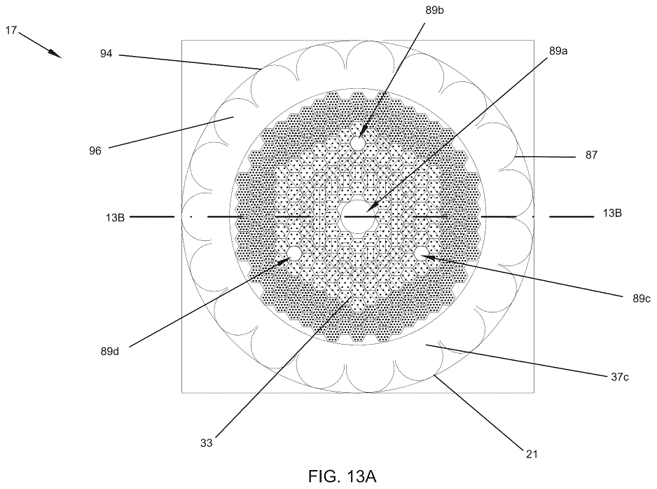

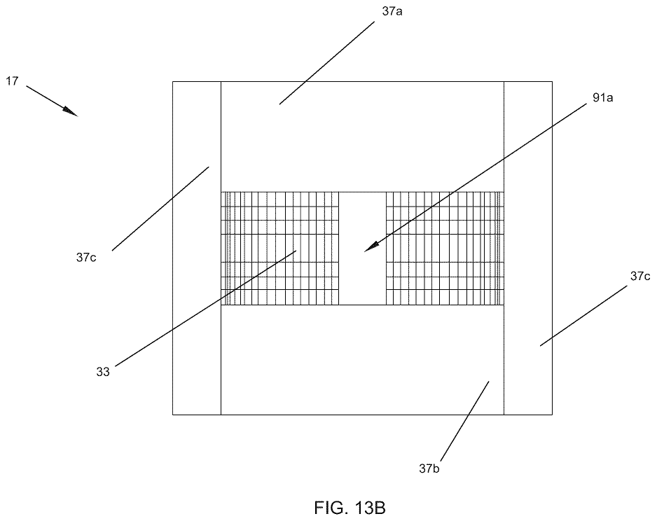

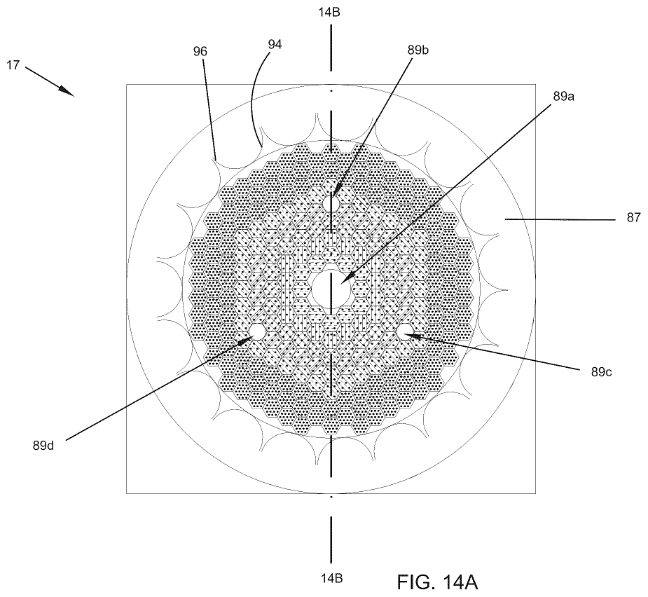

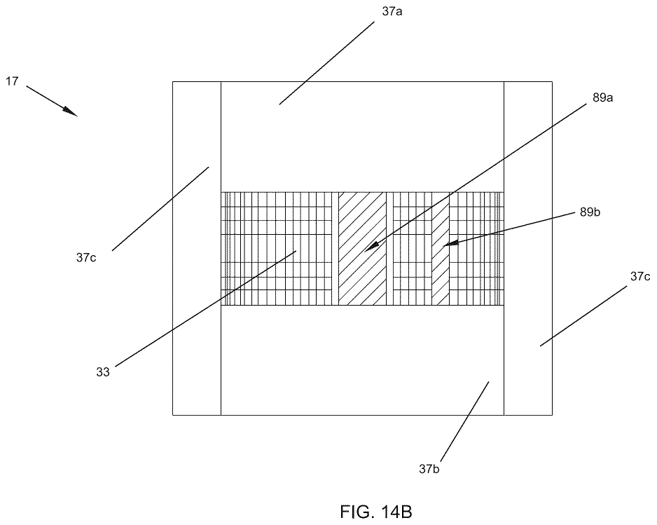

FIG. 13A illustrates a top plan view of a nuclear reactor 17 with a reactor control and shutdown system 29 disengaged and FIG. 13B illustrates a cross-sectional view of the solid core 33 along axis 13B-13B shown in FIG. 13A in accordance with some embodiments. The capability of shutting down the nuclear reactor 17 and controlling reactivity is an important safety feature of nuclear reactors 17. As such, the nuclear reactor 17 may include a reactor control and shutdown system (RCSS) 29. The RCSS 29 may include one or more control drums 87 and one or more control rods 89a-d, as best seen in FIG. 14A. The one or more control rods 89a-d may be disposed in one or more voids 91a-d defined by the solid core 33. In some embodiments, the voids 91a-b may be spherical, hexagonal, pentagonal, or some other suitable shape. It is noted that only one control drum 87 is called out in FIG. 13A for clarity. It will be appreciated that the RCSS may include just control drums 87, just control rods 89a-d, or a combination thereof.

The control drums 87 may be positioned at the solid core 33 periphery. The control drums 87 may have a first side 94 (illustrated as the convex portion of the control drum 87) and a second side 96 (illustrated as the concave portion of the control drum 87). In some embodiments the first side 94 and the second side 96 may be asymmetric. The shape of the control drums 87 may be any suitable shape such that they can be rotated within the interior cavity 54 of the vessel 21. For example, the control drums 87 may be cylindrical. In some embodiments, the control drums 87 may rotate up to 124.75 cm or more from the nuclear reactor 17 vertical axis of symmetry. In some embodiments, each control drum 87 may be 2 cm thick and may have an inner radius of 17 cm. In some embodiments, there may be up to twenty or more control drums 87 that are equally spaced covering the entire circumference of the solid core 33. It will be appreciated that there may be more than twenty control drums 87 or less than twenty control drums 87 in some embodiments. In some embodiments, the control drums 87 are located within the radial reflector, such as the reflector 37c.

The first side 94 may be covered with a neutron absorbing material, such as boron carbide (B₄C) or some other suitable neutron absorbing material such as lead. The second side 96 may be made of a reflector material, such as BeO, as steel, steel alloy, inconel, silicon carbide, tungsten carbide, graphite, a carbon allotrope, or some other suitable reflector neutron reflector material. The control drums 87 may be placed at the outer periphery of the solid core 33 and configured to rotate such that the first side 94 or the second side 96 may be facing the solid core 33. The rotation of the control drums 87 facilitates the selective control of reactivity in the solid core 33. For example, when the second side 96 of the control drums 87 are facing the solid core 33, as best seen in FIG. 13A, the RCSS may be considered to be “disengaged” and the reflector material of the second side 96 may facilitate reflection of neutrons back into the solid core 33 during critical operations. As another example, when the first side 94 of the control drums 87 are facing the solid core 33, as best seen in FIG. 14A, the RCSS may be considered to be “engaged” and the neutron absorbing material of the first side 94 may absorb neutrons leaving the solid core 33 to ensure the nuclear reactor 17 is shutdown.

FIG. 14A illustrates a top plan view of a nuclear reactor 17 with a reactor control and shutdown system 29 engaged and FIG. 14B illustrates a cross sectional view of the nuclear reactor 17 along axis 14B-14B shown in FIG. 14A in accordance with some embodiments. As discussed above, the RCSS 29 may include one or more control rods 89a-d. The one or more control rods 89a-d may include a neutron absorbing material (e.g., B₄C, lead, etc.), such that when one or more of the one or more control rods 89a-d are inserted into the solid core 33, reactivity is selectively controlled during critical operations or to shut down the nuclear reactor 17.

In some embodiments, the control rods 89a-d are the same size. In other embodiments, the control rods 89a-d may be a different size. In some embodiments, the control rods 89a-d may be solid. In other embodiments, the control rods 89a-d may be hollow such that they each define an inner absorber portion and an outer absorber portion. For example, the RCSS 29 may include a larger central control rod 89a that is disposed in the center void 91a of the solid core 33, and one or more smaller control rods 89b-d disposed around the solid core 33 at some predetermined distance from the central control rod 89a. A central void 91a and corresponding control rod 89a may help reduce power peaking within the solid core 33.

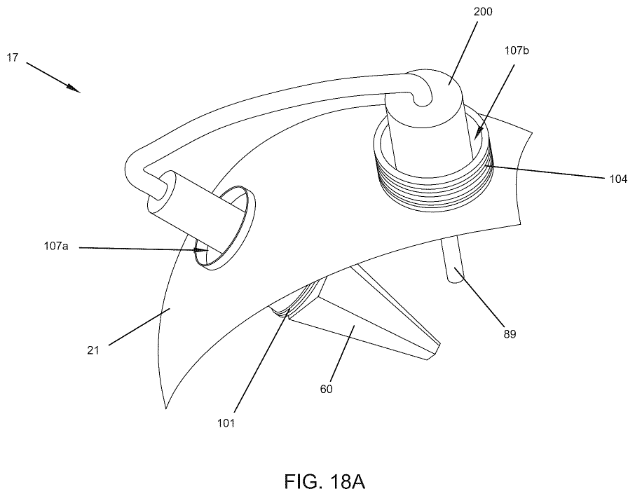

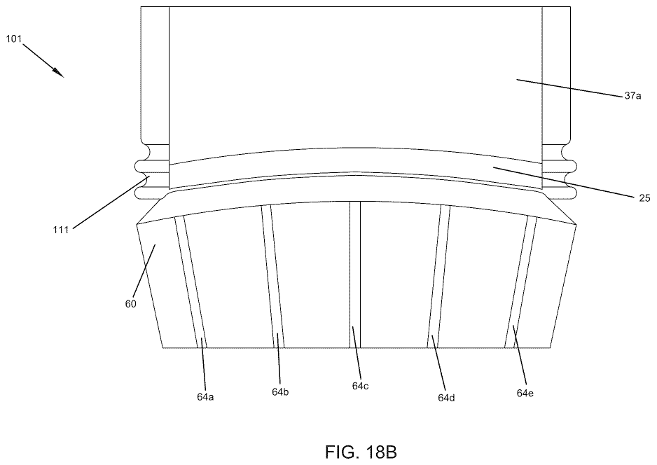

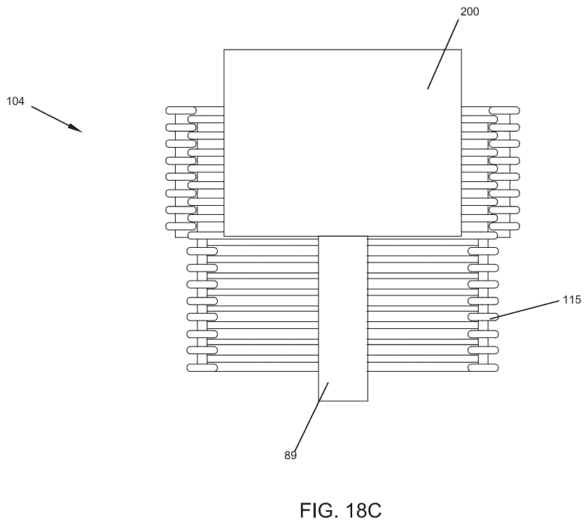

As best seen in FIGS. 13A-13B, the control rods 89a-d may be withdrawn from the solid core 33 during critical operations so that the control rods 89a-d are no longer absorbing neutrons in the solid core 33. As best seen in FIGS. 14A-14B, the control rods 89a-d may be inserted into the solid core 33 to shut down the nuclear reactor 17 by absorbing neutrons within the solid core 33. In some embodiments, one or more of the control rods 89a-d may be partially inserted into the solid core 33 to control reactivity in the solid core 33 during critical operations. For example, the outer control rods 89b-d may be withdrawn and the central control rod 89a may be partially inserted into the solid core 33 and selectively controlled during critical operations to control reactivity in the solid core 33. In some embodiments, the control drums 87 may be used to control reactivity during critical operations and the control rods 89a-d may be used to shut down the nuclear reactor 17. In some embodiments, both the control drums 87 and the control rods 89a-d may be able to independently maintain the system subcritical in any condition. It will be appreciated that the control rods 89a-d and the control drums 87 may be manually operated or operated in some other way, such as with one or more motors 200 as best seen in FIG. 18C.

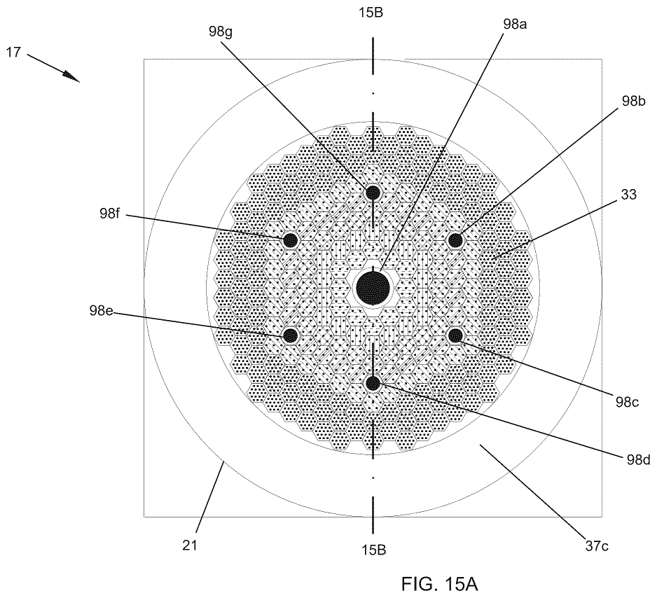

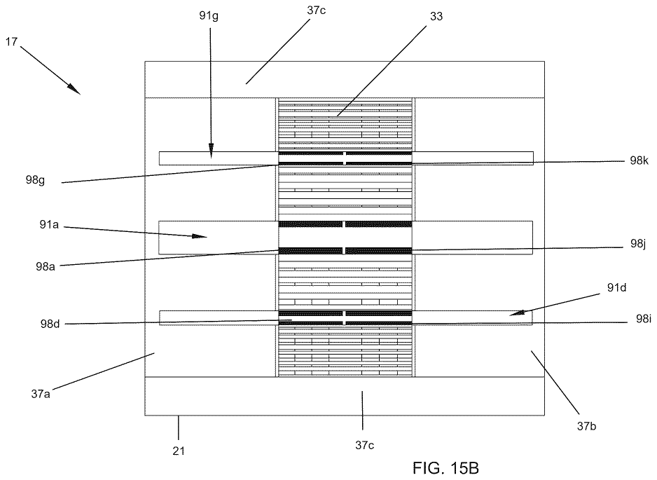

FIGS. 15A-17B illustrate split control rods 98a-n of the RCSS in accordance with some embodiments. In some embodiments, the RCSS 29 may have one or more split control rods 98a-n that are inserted and withdrawn from different positions around the nuclear reactor 17. For example, FIG. 1 illustrates a plurality of split control rods 98a-g on one side of the nuclear reactor 17 and a plurality of split control rods 98h-i on the opposite side of the nuclear reactor 17. Although only split control rods 98h-i are shown on the back side of the nuclear reactor 17 in FIG. 1, it will be appreciated that the RCSS 29 may include additional split control rods 98. For example, a cylindrical nuclear reactor 17 and solid core 33 may have a RCSS 29 that has a number of split control rods 98 on one side of the nuclear reactor 17 and a corresponding number of split control rods 98 on the opposite side of the nuclear reactor 17 such that they are inserted into and withdrawn from the same voids 91a-g from opposite ends. The split control rods 98a-n may be the same or similar to the control rods 89a-d discussed above.

The one or more split control rods 98a-n may include a neutron absorbing material (e.g., B₄C, lead, etc.), such that when one or more of the one or more split control rods 98a-n are inserted into the solid core 33, reactivity is selectively controlled during critical operations or to shut down the nuclear reactor 17. In some embodiments, the split control rods 98a-n are the same size. In other embodiments, the split control rods 98a-n may be a different size. For example, the RCSS 29 may include larger central split control rods 98a and 98j that are disposed in the center void 91a of the solid core 33, and one or more smaller split control rods 98b-n disposed around the solid core 33 at some predetermined distance from the central split control rods 98a, 98j. In embodiments with a spherical vessel 21 and solid core 33, the split control rods 98a-n may be dispersed around the solid core 33 at some predetermined distance from each other.

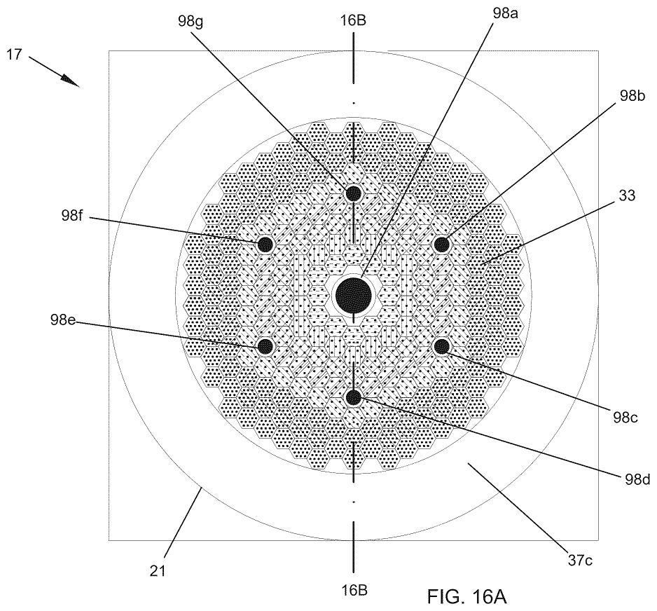

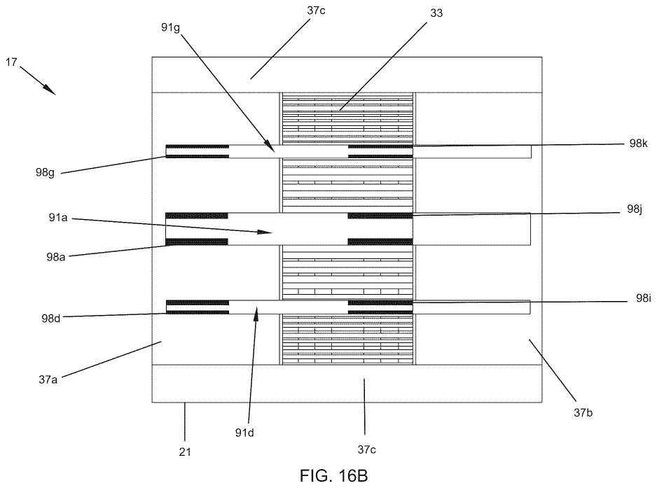

As best seen in FIG. 15B, the control rods 98a-n may be inserted into the solid core 33 from various direction (e.g., the first side and the second side of the nuclear reactor 17 as illustrated in FIG. 1) to shut down the nuclear reactor 17 by absorbing neutrons within the solid core 33. As best seen in FIG. 16B, one or more of the control rods 98a-n may be partially inserted into the solid core 33 to control reactivity in the solid core 33 during critical operations. For example, one or more split control rods 98 may be withdrawn and one or more split control rods 98a-n may be partially inserted into the solid core 33, such as 98j shown in FIG. 16B, and selectively controlled during critical operations to control reactivity in the solid core 33.

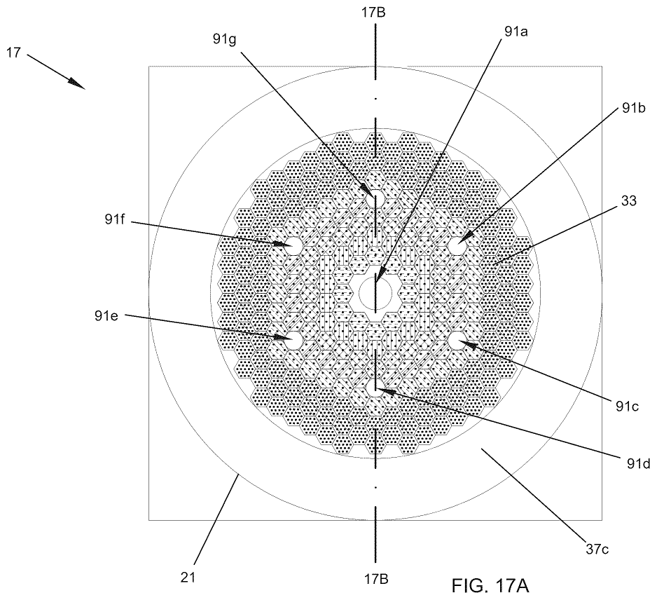

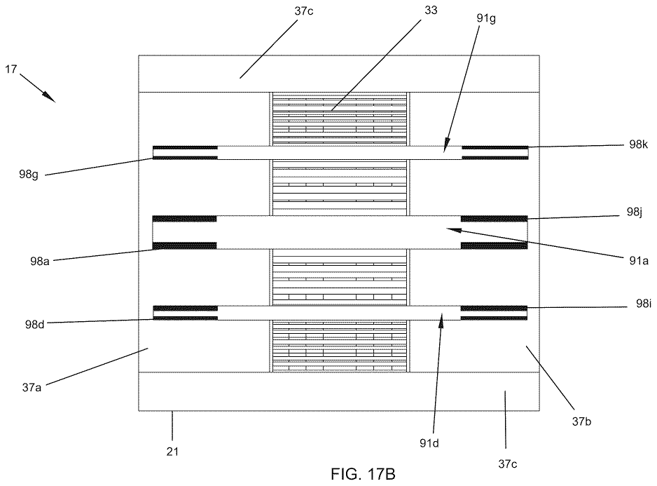

As best seen in FIGS. 17A-17B, the control rods 98a-n may be withdrawn from the solid core 33 during critical operations so that the control rods 98a-n are no longer absorbing neutrons in the solid core 33. In some embodiments, control drums 87 may be used to control reactivity as well as discussed above.

In some embodiments, the split control rods 98a-n may be solid. In other embodiments, the split control rods 98a-n may be hollow such that they each define an inner absorber portion and an outer absorber portion. In some embodiments, one or more of the split control rods 98a-n may have an inner absorber radius of 8 cm and an outer absorber radius of 12 cm. In some embodiments, each of the radial split control rods (e.g., split control rods 98b-g shown in FIG. 15A) may have an inner absorber radius of 3 cm and an outer absorber radius of about 5 cm. In some embodiments, each of the one or more split control rods 98a-n may be about 24.5 cm in length. In some embodiments, each of the one or more split control rods 98a-n may be enclosed in a metallic, cylindrical case. In some embodiments, the metallic, cylindrical case may be 5 mm thick.

FIG. 18A illustrates a portion of a nuclear reactor 17 in accordance with some embodiments. Heat generated by the fuel 74 in the solid core 33 may require additional thermal management considerations. For example, the nuclear reactor 17 may include one or more fuel element bellows 101 and one or more rod bellows 104 disposed within one or more respective penetrations 107a-b in the vessel 21 that can accommodate thermal expansion of the fuel elements 60a-n and the control rods 89a-n.

FIG. 18B illustrates a detail view of the fuel element bellows 101 in accordance with some embodiments. The more of the fuel elements 60a-n in the solid core may include a fuel element bellows 101 placed adjacent the respective fuel element 60. The fuel element bellows 101 may include a portion of a heat exchanger 25 disposed therein to remove heat from the fuel element 60 that is generated by the fuel 74. The fuel element bellows 101 may also include a reflector 37a disposed therein to the reflect neutrons back into the solid core 33. The fuel element bellows 101 may include a flexible portion 111 that can expand and contract with temperature changes within the solid core 33. For example, the fuel element bellows 101 may expand during critical operations and contract when the nuclear reactor 17 is shutdown.

FIG. 18C illustrates a detail view of a rod bellows 104 as shown in FIG. 18A in accordance with some embodiments. The one or more control rods 89a-n (or split control rods 98a-n) and its associated motor 200 may be disposed within the rod bellows 104. The rod bellows 104 may include a flexible portion 115 that can expand and contract with temperature changes within the solid core 33. For example, the rod bellows 104 may expand during critical operations and contract when the nuclear reactor 17 is shutdown.

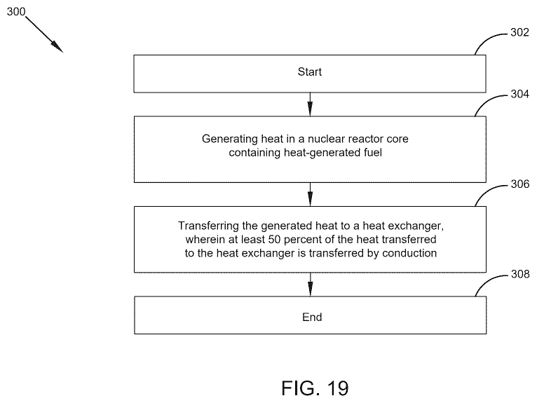

FIG. 19 illustrates one example of a method 300 of transferring heat in a nuclear reactor 17 in accordance with some embodiments. The method 300 may begin at block 302. Block 304 may include generating heat in a nuclear reactor 17 core 33 containing heat-generating fuel 74. Block 306 may include transferring the generated heat to a heat exchanger 25. At least 50 percent of the heat transferred to the heat exchanger 25 may be transferred by conduction. In some embodiments, the method 300 may include providing, within the core 33, one or more solid matrices, each defining one or more channels 64. The method 300 may include disposing the heat-generating fuel 74 within the one or more channels 64. In some embodiments, the one or more solid matrices comprise one or more of aluminum nitride, beryllium oxide, graphite, graphene or other carbon allotrope materials, synthetic diamond, beryllium carbide, ceramic, and silicon carbide. In some embodiments, the heat-generating fuel 74 comprises one or more of uranium dioxide, uranium nitride, and uranium carbide.

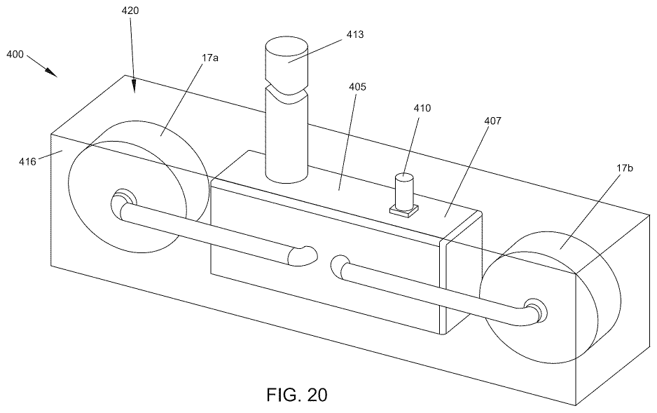

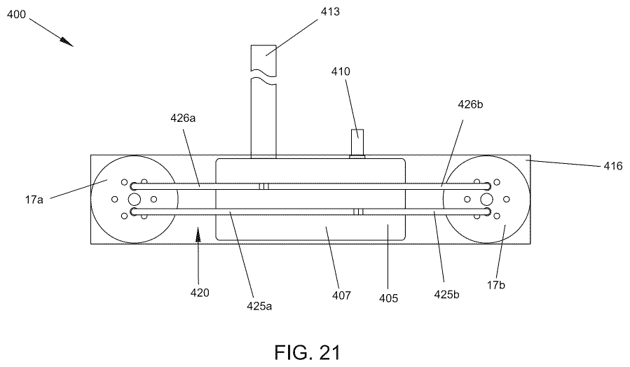

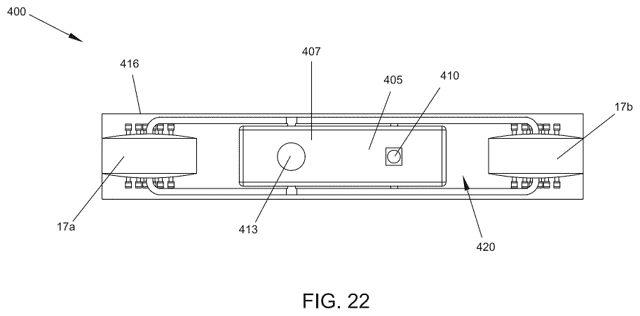

FIGS. 20-22 illustrate one example of a power generation system 400 in accordance with some embodiments. The power generation system 400 may include one or more nuclear reactors 17a-b and an electric generating system 405. In some embodiments, the electric generating system 405 may include a housing 407 such that one or more of the components of the electric generating system 405 are disposed within the housing 407. The electric generating system 405 may include a secondary medium intake 410 and a secondary medium exhaust 413.

In some embodiments, the power generation system 400 may be sized to fit in a shipping container 416 (e.g., a 45 ft. high cube container). For example, the shipping container 416 may define an interior space 420 that is sized to receive the power generation system 400. In some embodiments, the electric generating system 405 may be disposed between, or intermediate, the one or more nuclear reactors 17a-b. In embodiments where the vessel 21 is cylindrical, the longitudinal axis of the cores 33 and vessels 21 of each of the one or more nuclear reactors 17a-b may be oriented horizontally.

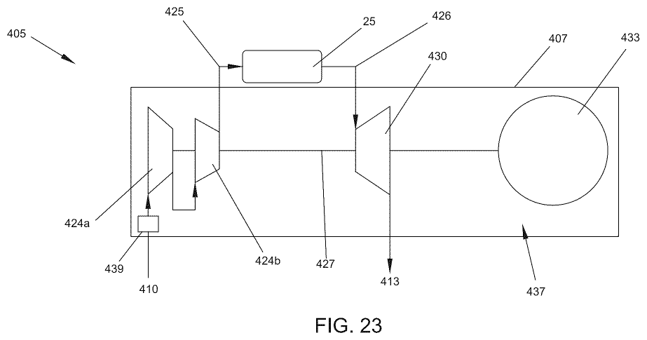

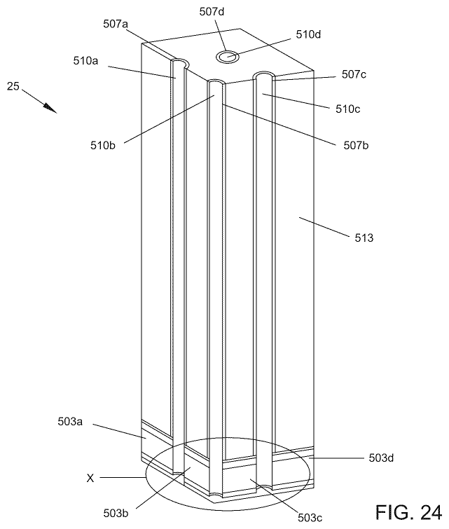

FIG. 23 illustrates aspects of the electric generating system 405 in accordance with some embodiments. The electric generating system 405 may include one or more compressors 424a-b driven by a shaft 427, the one or more heat exchangers 25, one or more turbines 430 driving the shaft 427, and one or more generators 433. As discussed above, one or more components of the electric generating system 405 may be disposed within a space 437 defined by the housing 407. As shown in FIG. 23 and discussed in more detail herein, the one or more heat exchangers 25 may be external to the housing 407. For example, the one or more heat exchangers may be thermally coupled to the vessels 21 of the one or more nuclear reactors 17a-b.

In some embodiments, the secondary medium may enter the electric generating system 405 through the secondary medium intake 410. The secondary medium may pass through one or more filters 439 to filter out any particulates. In some embodiments, the one or more filters 439 may be coupled to the intake 410. The secondary medium may then pass through the one or more compressors 424a-b driven by the shaft 427. The secondary medium may then leave the one or more compressors 424a-b and proceed to the one or more heat exchangers 25 through one or more supply piping 425a where the secondary medium may absorb heat generated from the one or more nuclear reactors 17a-b. The secondary medium may then proceed to the turbine 430 through one or more return piping 426, which may drive the shaft 427 used by the generator 433 to generate electricity. The secondary medium may then be discharged through the exhaust 413, or chimney.

In some embodiments, the secondary medium may be a fluid, such as air or some other suitable medium (e.g., liquid, gas, etc.). The electric generating system 405 may be an open-loop system, such as an open-loop Brayton cycle. A Brayton cycle is a thermodynamic cycle which uses one or more compressors to compress a gas (e.g., air), a heat exchanger to heat the compressed gas, and a turbine to expand the compressed gas, which can then be used by a generator to generate electricity. Open-loop Brayton cycles may have a smaller efficiency than a closed-loop alternative. However, this open-loop Brayton cycle may use a smaller number of components and may have a simpler design, which may allow for lower operating and maintenance costs. In some embodiments, an open-loop Bryton cycle may achieve an efficiency of ˜30% when using the highest efficiency turbomachinery. More common, off-the-shelf machinery may reduce the efficiency to 15-22%. Reducing the pressure losses within the electric generating system 405 may increase the cycle efficiency.

The turbine 430 inlet temperature may be limited by the reactor vessel 21 material (e.g., 982° C. for Hastelloy) and/or by the heat transfer mode (e.g., conduction, convection, irradiation) taking place within the vessel. In some embodiments, the turbine 430 inlet temperature may be 50-100° C. below the vessel 21 material limit. In some embodiments, the turbine 430 inlet temperature may have a large impact on the overall cycle thermodynamic performance. The higher the turbine 430 inlet temperature, the better efficiency of the thermodynamic cycle. The reactor vessel 21 may include a working gas to enhance the heat transfer to the vessel 21 walls in order to allow for higher temperatures at the turbine 430 inlet

In some embodiments, the turbine (η_{turb}) and compressor (η_{comp}) isentropic efficiencies, may have an effect on the Brayton cycle performance. For example, a η_{comp} equal to 0.75 and η_{turb} equal to 0.80 may result in a cycle efficiency of ˜15%. A η_{comp} equal to 0.80 and η_{turb} equal to 0.85 may yield a cycle efficiency of 22-23% with compression rations between 10-15 and an air flow rate lower than 1.5 m³ /s according to some embodiments. In some embodiments, a η_{comp} equal to 0.85 and a η_{turb} equal to 0.90 may yield cycle efficiencies in the range 30-32% with compression ratios between 15 and 20 and air flow rate of less than 0.8 m³ /s.

Although the thermodynamic cycle discussed above for the electric generating system 405 is described as an open-loop system, it will be appreciated that the electric generating system 405 may be modified to include a closed-loop system. For example, the electric generating system may not include an intake 410 or an exhaust 413, and the secondary medium may be cooled down after passing through the turbine 430 to return the secondary medium to initial conditions and then proceed back through the system (e.g., back to the one or more compressors 424a-b).

FIG. 24 illustrates aspects of one example of the one or more heat exchangers 25 in accordance with some embodiments. As discussed above, the one or more heat exchangers 25 may be thermally coupled to the vessel 21 of the one or more nuclear reactors 17a-b at a heat transfer interface. The one or more heat exchangers 25 may include one or more heat exchanger modules 503a-d that are coupled to one or more inlet/outlet manifolds. The inlet/outlet manifolds may include one or more supply channels 507a-d and one or more return channels 510a-d. In some embodiments, one or more of the heat exchanger 25 components (e.g., the heat exchanger modules 503a-d, the supply channels 507a-d, and the return channels 510a-d) may be at least partially disposed in a reflector 513, which may be one of the reflectors 37a-c discussed above. For example, the supply channels 507a-d and the return channels 510a-d may be disposed within the reflector 513 as illustrated in FIG. 24. In some embodiments, the one or more return channels 510a-d may be fluidically isolated from the supply channels 507a-d. In some embodiments, at least one of the supply channels 507a-d may be coaxial with one of the return channels 510a-d. In some embodiments, the supply channels 507a-d and/or the return channels 510a-d may be planar, curved, spherical, or some other suitable shape.

In some embodiments, the number of heat exchanger modules 503a-d for a given heat exchanger 25 may correspond to the number of fuel elements 60, or matrices, in the core 33 of the nuclear reactors 17a-b. In some embodiments, the size and shape of the heat exchanger modules 503a-d may correspond to the size and shape of the fuel elements 60, or matrices, in the core 33 of the nuclear reactors 17a-b. As an example, a cylindrical nuclear reactor 17 may include two heat exchangers 25, one on each end of the reactor vessel 21. Each of these heat exchangers 25 may include the same number of heat exchanger modules 503a-d that are the same size and shape of the fuel elements 60 such that each heat exchanger module 503a-d is coupled to the outside of the vessel 21 at a location corresponding to a respective fuel element 60 on the inside of the vessel 21.

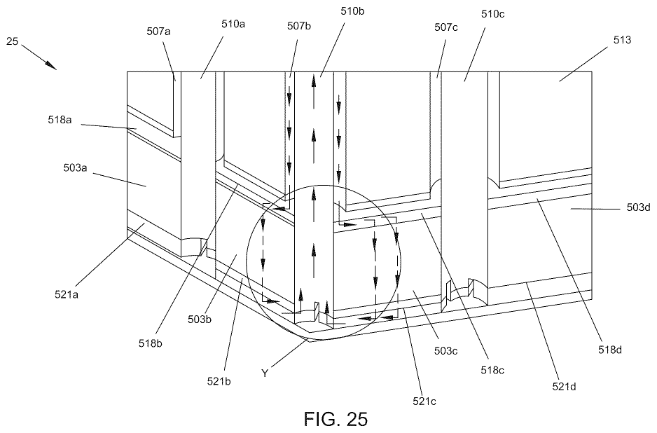

FIG. 25 illustrates aspects of the heat exchanger 25 from detail X shown in FIG. 24 in accordance with some embodiments. As discussed above, the secondary medium may travel from the intake 410 and through the supply channels 507a-c to the heat exchanger modules 503a-d. The secondary medium may travel through an inlet surface 518a-d of each of the heat exchanger modules 503a-d, where the secondary medium may absorb the heat from the vessel 21 wall and/or the heat exchanger modules 503a-d. The secondary medium may then travel through the outlet surface 521a-d of the heat exchanger modules 503a-d and to the return channels 510a-c, where the secondary medium returns to the electric generating system 405 as discussed above.

In some embodiments, the secondary medium flows from the inlet surface 518a-d to the outlet surface in 2-30 milliseconds. In some embodiments, the secondary medium flows from the inlet surface 518a-d to the outlet surface 521a-d in less than 15 milliseconds. In some embodiments, the secondary medium flows from the inlet surface 518a-d to the outlet surface 521a-d in less than 5 milliseconds.

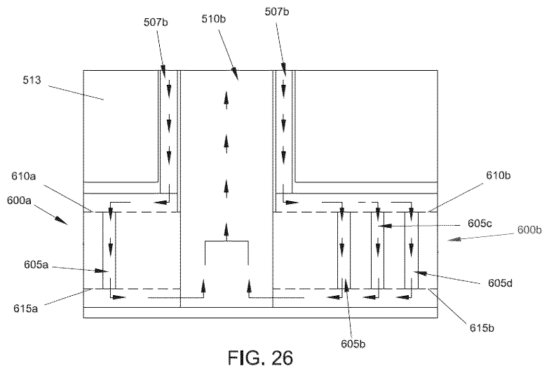

FIG. 26 illustrates a cross-sectional view of a first example of the heat exchanger module 600 using detail Y shown in FIG. 25 in accordance with some embodiments. Heat exchanger modules 600a-b may include many of the same or similar features of heat exchanger modules 503a-d discussed above. In this first example, the one or more heat exchangers 25 may include one or more heat exchanger modules 600a-b that each define a plurality of channels 605a-d, or a matrix of pores. In some embodiments, the plurality of channels 605a-d may be micro-channels. Thus, using FIG. 26 as an example, the secondary medium may flow through the supply channels 507b, through the inlet surfaces 610a-b, through the plurality of channels 605a-d, through the outlet surfaces 615a-b, and to the return channel 510b. In some embodiments, the plurality of channels 605a-d may have a diameter of about 0.25 millimeters and may be distributed in the heat exchanger module 600 with a pitch of about 0.4 millimeters.

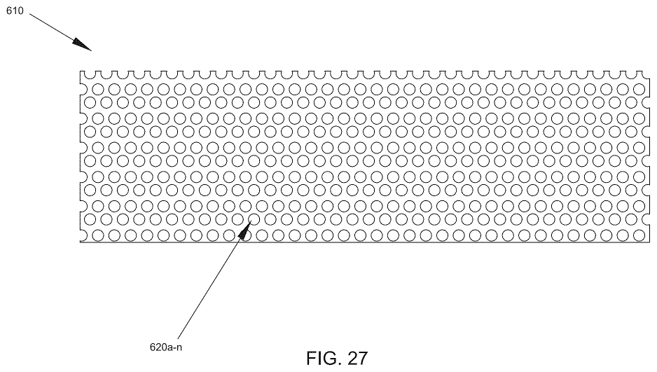

FIG. 27 illustrates a top view of the inlet surface 610 of the first example of the heat exchanger module 600 in accordance with some embodiments. The inlet surface 610 may define a plurality of inlet holes 620a-n that correspond to the plurality of channels 605a-d through the heat exchanger module 600. For example, the secondary medium may flow through the supply channels 507a-d and through the inlet holes 620a-n of the inlet surface 610 such that the secondary medium is distributed into each of the plurality of channels 605a-d.

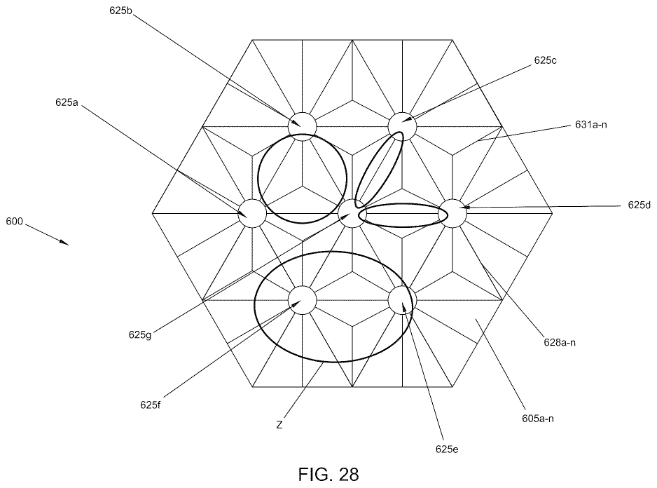

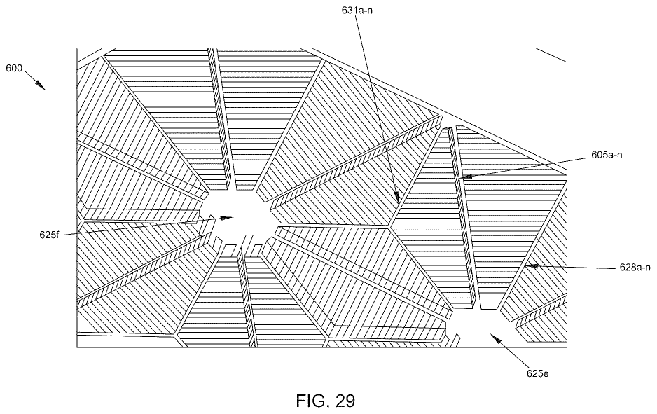

FIG. 28 illustrates a side view of the first example of the heat exchanger module 600 in accordance with some embodiments. The heat exchanger module 600 may define a plurality of outlet holes 625a-g at the outlet surface 615 of each heat exchanger module 600.

After the secondary medium flows through the inlet surface 610, the secondary medium may be distributed through the plurality of channels 605a-n and ultimately may flow through the outlet holes 625a-g. In some embodiments, the heat exchanger module 600 may define a plurality of planar return channels 628a-n. In some embodiments, the heat exchanger module 600 may define a plurality of curved return channels 631a-n. In some embodiments, the heat exchanger module may define a plurality of planar return channels 628a-n and a plurality of curved return channels 631a-n.

FIG. 29 illustrates an isometric view of the first example of the heat exchanger module 600 from detail Z shown in FIG. 28. The purpose of the planar return channels 628a-n and/or the curved return channels 631a-n may be to receive the secondary medium from the plurality of channels 605a-n and distribute the secondary medium to the outlet holes 625a-g. For example, the plurality of planar return channels 628a-n may direct the secondary medium directly to one of the outlet holes 625a-g. The plurality of curved return channels 631a-n may direct the secondary medium along a curved path to one or more of the outlet holes 625a-g.

In some embodiments, the surface to volume ratio of the heat exchanger module 600 may be greater than 400 m² /m³.

In some embodiments, the heat exchanger modules 600 may be the same number, size, and/or shape of the fuel elements 60 in the core 33. For example, the heat exchanger modules 600 may be hexagonal and may define a central return channel, or outlet hole 625g, such that the rest of the return channels, or outlet holes 625a-f, are arranged in a hexagonal pattern around the central channel, or outlet hole 625g. In some embodiments, the plurality of heat exchanger modules 600 may be arranged in concentric rings. In some embodiments, the heat exchanger modules 600 may be pentagonal. In some embodiments, the heat exchanger modules 600 may be up to 2 cm thick or more.

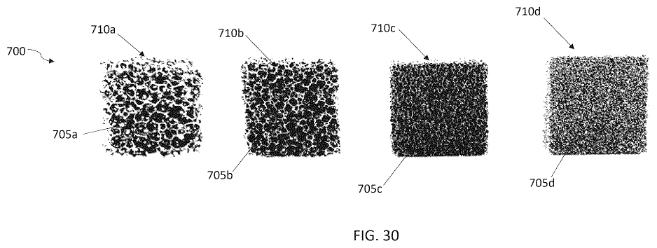

FIG. 30 illustrates side views of aspects of a second example of heat exchanger modules 700 in accordance with some embodiments. Heat exchanger modules 700 may include many of the same or similar features of heat exchanger modules 600 and/or heat exchanger modules 503a-d discussed above. The heat exchanger modules 700 may be coupled to the vessel 21 of the reactor 17 in the same manner as discussed above. However, instead of a plurality of channel 605a-d, the heat exchanger modules 700 may include one or more layers, or matrices 705a-d. The matrices 705a-d may each define a plurality of pores 710a-d configured to effect flow of the secondary medium through the plurality of pores 710a-d. For example, referring back to FIG. 25 as an example, the secondary medium may flow through the supply channels 507a-d, through the inlet surface 518a-d of each of the heat exchanger modules 700, through plurality of pores 710a-d of the one or more matrices 705a-d, out through the outlet surface 521a-d, and back through the return channels 510a-d. As the secondary medium flows through the heat exchanger modules 700, the secondary medium absorbs heat generated in the vessels 21 of the one or more nuclear reactors 17a-b.

In some embodiments, the matrices 705a-d may include a ceramic foam. In some embodiments, the matrices 705a-d may include a silicon carbide foam. In some embodiments, the pore density of the matrices 705a-d may be between 5 and 120 pores per inch (PPI). For example, matrix 705a may be a coarse porous material with a low ppi, such as in the range of 5 -15 ppi. Matrix 705b may be a first intermediate porous material with an intermediate ppi, such as in the range of 16-40 ppi. Matrix 705c may be a second intermediate porous material with an intermediate ppi, such as in the range of of 41-75 ppi. Matrix 705d may be a fine porous material with a high ppi, such as in the range of 76-120 ppi. It will be appreciated that the matrices 705a-d may have any variation of pore density and that the pore density of matrices 705a-d are provided as non-limiting examples. In some embodiments, the surface to volume ratio of the matrices 705a-d may be between 100 and 8000 m² /m³, which may correlate to the pore density of the matrices 705a-d (e.g., the lower the pore density, the lower the surface to volume ratio).

In some embodiments, the secondary medium flows from the inlet surface 518a-d to the outlet surface 521a-d of each of the heat exchanger modules 700 in less than 100 milliseconds. In some embodiments, the secondary medium flows from the inlet surface 518a-d to the outlet surface 521a-d of each of the heat exchanger modules 700 in less than 15 milliseconds.

In some embodiments, the number, size, and/or shape of the heat exchanger modules 700 may correspond to the fuel elements 60 in the core. In some embodiments, the plurality of heat exchanger modules 700 may be arranged in concentric rings. In some embodiments, the heat exchanger modules 700 may be spherical, hexagonal, pentagonal, or some other suitable shape. In some embodiments, the heat exchanger modules 700 may be up to 2 cm thick or more.

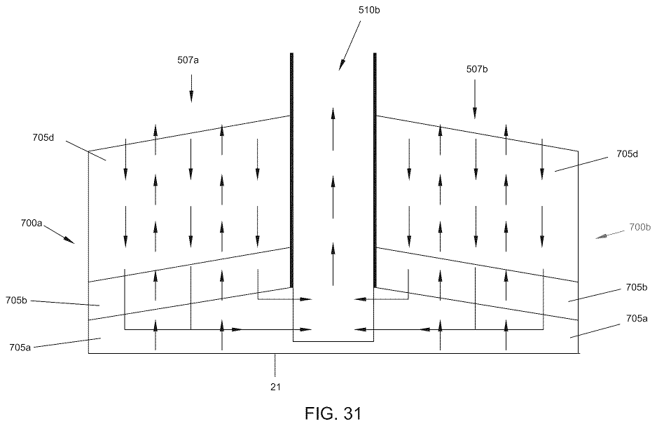

FIG. 31 illustrates a cross-sectional view of aspects of the second example of the heat exchanger modules 700 using detail Y shown in FIG. 25 in accordance with some embodiments. As discussed above, the heat exchanger modules 700a-b may include one or more layers, or matrices 705a-d, disposed between the inlet surfaces 518a-d and the outlet surfaces 521a-d. In some embodiments, the heat exchanger modules 700a-b may include multiple layers, or matrices 705a-d, with differing porosities. As best seen in FIG. 31, one or more of the heat exchanger modules 700a-b may include a first matrix 705d (or 705c) with an intermediate to fine porous material adjacent the inlet surface 518 such that it is the first matrix 705 to receive the secondary medium from the supply channels 507a-b. The heat exchanger modules 700a-b may include a second matrix 705b with an intermediate porous material adjacent the first matrix 705d such that the secondary medium flows from the first matrix 705d to the second matrix 705b. The heat exchanger modules 700a-b may include a third matrix 705a with coarse porous material such that the secondary medium flows from the second matrix 705b to the third matrix 705a. The secondary medium then flows from the third matrix 705a to the return channel 510b and back to the electric generating system 405.

In embodiments with heat exchanger modules 700a-b, heat is transferred through the matrices 705a-b and 705d, away from the vessel 21 wall, as best seen in FIG. 31. The secondary medium absorbs the heat as it travels through the various matrices 705a-b and 705d. By differing the pore density in the heat exchanger modules 700, the secondary medium interacts with some matrices 705a-d more than others due to the difference in surface to volume ratios. In some embodiments, the matrix 705a nearest the vessel wall 21 is designed such that the pores 710a redirect the secondary medium into the return channel 510b.

Although heat exchanger modules 700 have been discussed with reference to specific matrices 705a-d, a person of ordinary skill in the art would appreciate that other matrix 705a-d combinations or layers may be used to accomplish the application's heat transfer requirements. Although heat exchangers 25, and the various heat exchanger modules 503a-d, 600, and 700, have been disclosed as removing heat from the one or more nuclear reactors 17a-b, it will be appreciated that the heat exchangers 25 may be used in other thermal transfer applications where the secondary medium is used to heat up an object for thermal regulation. For example, the heat exchanger 25 may be a thermal transfer unit thermally coupled to an object at a thermal interface portion. The thermal transfer unit may be configured to regulate temperature of the object with the secondary medium. Meaning the secondary medium may be used to heat or cool down the object. In fact, the system may be set up such that the thermal transfer unit may selectively heat up and/or cool down the object based on the object's thermal needs.

In some embodiments, the heat exchanger modules 503a-d, 600, or 700 may be made of inconel alloy 800h-alloy 800h/at, alloy 230-uns n06230 , alloy 556-uns r30556 , alloy x-uns n06002, alloy 601-alloy 601, stainless steel 347-s34709, inconel 617 uns n06617 or some other suitable material, such as one of the materials discussed above regarding the vessel 21. In some embodiments, the heat exchanger modules 503a-d, 600, 700 may be made by metal additive manufacturing.

### Features of the Disclosure

### Solid Core

In some embodiments, a nuclear reactor may include a vessel having a wall defining an interior cavity. The nuclear reactor may include a core disposed within the interior cavity. The core may include heat-generating fuel and a primary medium for transferring heat from said fuel to an outer boundary of said core. Said primary medium may be one or more solid materials.

In some embodiments, said primary medium may include at least one matrix that defines at least one channel, wherein fuel may be disposed within the at least one channel. In some embodiments, the at least one matrix may include one or more of aluminum nitride, beryllium oxide, graphite, carbon allotrope material, synthetic diamond, beryllium carbide, ceramic, and silicon carbide. In some embodiments, the fuel may include one or more of uranium dioxide, uranium nitride, and uranium carbide. In some embodiments, the fuel may include one or more of uranium dioxide, uranium nitride, and uranium carbide. In some embodiments, the vessel may include one or more of alloy 800h-alloy 800h/at, alloy 230-uns n06230, alloy 556-uns r30556, alloy x-uns n06002, alloy 601-alloy 601, stainless steel 347-s34709, or inconel 617 uns n06617.

In some embodiments, the nuclear reactor may include at least one heat exchanger external to said vessel wall, wherein at least twenty (20) percent of heat transferred from the fuel to the at least one heat exchanger may be by one or more of conduction and irradiation. In some embodiments, at least fifty (50) percent of heat transferred from the fuel to the at least one heat exchanger may be by one or more of conduction and irradiation. In some embodiments, at least ninety (90) percent of heat transferred from the fuel to the at least one heat exchanger may be by one or more of conduction and irradiation. In some embodiments, the core and at least one heat exchanger may be thermally coupled to the vessel wall. In some embodiments, the outer boundary of the core may be spaced from said vessel wall and the space contains one or more gasses.

In some embodiments, said vessel and said core are cylindrical. In some embodiments, a heat exchanger is thermally coupled to each end of said cylindrical vessel. In some embodiments, said vessel and said core are spherical. In some embodiments, the nuclear reactor includes a heat exchanger that is spherical and thermally coupled to said spherical vessel.

In some embodiments, a nuclear reactor may include a vessel. The nuclear reactor may include a core disposed within said vessel. Said core may include a heat-generating fuel. The nuclear reactor may include one or more heat exchangers disposed external to the vessel. The nuclear reactor may include a primary medium for transferring heat generated by the fuel to the heat exchanger. At least twenty (20) percent of the heat transferred by the primary medium may be transferred by one or more of conduction and irradiation.

In some embodiments, at least fifty (50) percent of the heat transferred by the primary medium may be transferred by one or more of conduction and irradiation. In some embodiments, at least ninety (90) percent of the heat transferred by the primary medium may be transferred by one or more of conduction and irradiation.

In some embodiments, a system may include a nuclear reactor having a core comprising an active region containing a fissionable fuel operating at criticality within a predetermined temperature range. At least fifty (50) percent of heat transferred within said active region may be transferred by conduction only.

In some embodiments, at least ninety-five (95) percent of the material within said active region is in a solid state. In some embodiments, said core may include a plurality of fuel elements, said fuel elements may include a solid matrix material defining a plurality of channels, said fuel being disposed within said channels. In some embodiments, said solid matrix material may include one or more of aluminum nitride, beryllium oxide, graphite, carbon allotrope material, synthetic diamond, beryllium carbide, ceramic, and silicon carbide, and said fuel may include one or more of uranium dioxide, uranium nitride, and uranium carbide. In some embodiments, one or more of said fuel elements may include a hexagonal cross section. In some embodiments, one or more of said fuel elements comprises a pentagonal cross section.

In some embodiments, a method may include generating heat in a nuclear reactor core containing heat-generating fuel. The method may include transferring the generated heat to a heat exchanger. At least twenty (20) percent of the heat transferred to the heat exchanger may be transferred by one or more of conduction and irradiation.

In some embodiments, the method may include providing within the core one or more solid matrices each defining one or more channels. The method may include disposing the heat-generating fuel within the one or more channels. In some embodiments, said solid matrices may include one or more of aluminum nitride, beryllium oxide, graphite, carbon allotrope material, synthetic diamond, beryllium carbide, ceramic, and silicon carbide, and said fuel may include one or more of uranium dioxide, uranium nitride, and uranium carbide.

### Core Geometry and Materials

In some embodiments, a nuclear reactor may include a vessel having a wall defining an internal cavity. The nuclear reactor may include a core disposed within the internal cavity. The core may include one or more fuel elements comprising a solid matrix material defining one or more fuel channels. The core may include a fuel material disposed in the one or more fuel channels. The solid matrix material may form a primary medium for transferring heat generated by the fuel material to an external boundary of the core.

In some embodiments, the solid matrix material may include one or more of aluminum nitride, beryllium oxide, graphite, graphene or other carbon allotrope materials, synthetic diamond, beryllium carbide, ceramic, or silicon carbide. In some embodiments, the fuel material may include one or more of uranium dioxide, uranium nitride, or uranium carbide. In some embodiments, the fuel material may include one or more of uranium dioxide, uranium nitride, or uranium carbide. In some embodiments, the solid matrix material may include aluminum nitride and the fuel material may include one or more of is a uranium dioxide or uranium nitride. In some embodiments, the solid matrix material may include beryllium oxide and the fuel material may include one or more of uranium dioxide or uranium nitride. In some embodiments, the solid matrix material may include graphite and the fuel material may include one or more of uranium dioxide or uranium nitride.

In some embodiments, the nuclear reactor may include a gap between two or more fuel elements. One or more of lead, sodium, or helium may be disposed within the gap. In some embodiments, the one or more fuel elements may include a hexagonal or a pentagonal cross-section. In some embodiments, at least one of the one or more fuel elements includes a hexagonal cross-section and at least one of the one or more fuel elements includes a pentagonal cross-section. In some embodiments, the one or more fuel elements may define a plurality of fuel channels. In some embodiments, the one or more fuel elements may define at least seven fuel channels. In some embodiments, a pitch of the at least seven fuel channels may be forty millimeters. In some embodiments, the one or more fuel elements may define at least nineteen fuel channels. In some embodiments, a pitch of the at least nineteen fuel channels may be at least 10 millimeters but not more than 40 millimeters. In some embodiments, the pitch of the of the at least nineteen fuel channels may be forty millimeters. In some embodiments, at least one of the one or more fuel elements may include a hexagonal cross-section and at least one of the one or more fuel elements may include a pentagonal cross-section, and the core comprises a plurality of rings comprising a plurality of fuel elements. In some embodiments, the core may include a plurality of fuel elements defining seven fuel channels, and a plurality of fuel elements defining nineteen fuel channels.

In some embodiments, the core may be generally cylindrical. In some embodiments, the core may be generally spherical. In some embodiments, the vessel may include one or more of alloy 800h-alloy 800h/at, alloy 230-uns n06230 , alloy 556-uns r30556, alloy x-uns n06002, alloy 601-alloy 601, stainless steel 347-s34709, or inconel 617 uns n06617. In some embodiments, the vessel may be generally cylindrical. In some embodiments, the vessel may be generally spherical. In some embodiments, the fuel material may be in pellet form. In some embodiments, the fuel material may be tri-structural isotropic particles or ceramic metallic fuel particles. In some embodiments, the core may include a plurality of fuel elements. The fuel material may be differentially disposed along a length of one or more fuel channels. In some embodiments, the vessel and the core may be generally cylindrical and oriented such that a longitudinal axis is substantially horizontal. In some embodiments, the nuclear reactor may include a reflector material surrounding the vessel. In some embodiments, the reflector material may include one or more of beryllium oxide, steel, steel alloy, inconel, silicon carbide, tungsten carbide, graphite or a carbon allotrope material.

In some embodiments, a nuclear reactor may include a vessel having a wall defining an interior cavity. The nuclear reactor may include a generally cylindrical core disposed within the interior cavity. The core may include a plurality of hexagonal fuel elements and a plurality of pentagonal fuel elements arranged in concentric rings about a longitudinal axis of the core. Each fuel element may include a solid matrix material that defines a plurality of fuel channels. The core may include a fuel material disposed in the plurality of fuel channels.

In some embodiments, the solid matrix material may include one or more of aluminum nitride, beryllium oxide, graphite, synthetic diamond, beryllium carbide, ceramic, or silicon carbide. The fuel material may include one or more of uranium dioxide, uranium nitride, or uranium carbide. In some embodiments, one or more rings of fuel elements include fuel elements defining seven fuel channels, and one or more rings of fuel elements include fuel elements defining nineteen fuel channels. In some embodiments, the longitudinal axis of the generally cylindrical core may be oriented horizontally. In some embodiments, the nuclear reactor may include a reflector material surrounding the core or the vessel.

In some embodiments, a nuclear reactor may include a vessel having a wall defining an interior cavity. The nuclear reactor may include a generally spherical core disposed within the interior cavity. The core may include a plurality of hexagonal fuel elements and a plurality of pentagonal fuel elements extending radially from an inner radius to an outer radius of the core. Each fuel element may include a solid matrix material that defines a plurality of fuel channels. The core may include a fuel material disposed in the plurality of channels.

In some embodiments, the solid matrix material may include one or more of aluminum nitride, beryllium oxide, graphite, synthetic diamond, beryllium carbide, ceramic, or silicon carbide. The fuel material may include one or more of uranium dioxide, uranium nitride, or uranium carbide. In some embodiments, the core may include a plurality of fuel elements defining a plurality of channels, at least one of the plurality of channels with a first length and at least one of the plurality of channel with a second length. In some embodiments, the nuclear reactor may include a reflector material comprising an inner reflector disposed at a center of the core, and an outer reflector surrounding an outer boundary of the core.

### Reactor Control Shutdown System (RCSS)

In some embodiments, a nuclear reactor may include a vessel having a wall defining an interior cavity. The nuclear reactor may include a core disposed within the interior cavity. The core may include a plurality of fuel elements arranged parallel to a core axis. Each fuel element may include a solid matrix material defining a plurality of fuel channels. The core may include a fuel material disposed in the plurality of fuel channels. The core may include one or more control rod channels that are arranged parallel to the core axis and extend end-to-end through the core. The nuclear reactor may include a reactivity control system that may include one or more split control rods having a neutron absorbing material for insertion into the one or more control rod channels. Each split control rod may include a first portion for insertion into the control rod channel from a first end of the core and a second portion for insertion into the control rod channel from a second end of said core.

In some embodiments, the insertion or retraction of the first portion of a split control rod may be independent of the insertion or retraction of the second portion of the split control rod. In some embodiments, the core may be generally cylindrical. The core may include a central control rod channel at a central axis of the core and a plurality of radial control rod channels positioned around the central control rod channel at a predetermined radius. In some embodiments, the nuclear reactor may include a plurality of reactivity control drums positioned around a radial periphery of the core. Each drum may have a neutron reflecting portion and a neutron absorbing portion that are selectively oriented relative to the central axis of the core. In some embodiments, the selective orientation of each drum relative to the central axis of the core may be facilitated by rotation of each drum around a central axis of the drum. In some embodiments, each drum may be generally cylindrical. In some embodiments, each drum may be 2 cm thick and may have an inner radius of 17 cm. In some embodiments, there may be twenty or more drums.

In some embodiments, there may be three radial control rod channels positioned around the central control rod channel at a predetermined radius. In some embodiments, there may be six radial control rod channels positioned around the central control rod channel at a predetermined radius. In some embodiments, a central control rod of the one or more split control rods may have an inner absorber radius of 8 cm and an outer absorber radius of 12 cm.

In some embodiments, each of a plurality of radial control rods of the one or more split control rods may have an inner absorber radius of 3 cm and an outer absorber radius of about 5 cm. In some embodiments, each of the one or more split control rods may be about 24.5 cm in length. In some embodiments, a material of each of the one or more split control rods may include one or more of boron carbide or lead. In some embodiments, each of the one or more split control rods may be enclosed in a metallic, cylindrical case. In some embodiments, the metallic, cylindrical case may be 5 mm thick.

In some embodiments, a nuclear reactor may include a vessel having a wall defining an interior cavity. The nuclear reactor may include a spherical core disposed within the interior cavity. The spherical core may include a plurality of fuel elements. Each fuel element may extend from an outer periphery of the spherical core along a radius to a central portion of the spherical core. Each fuel element may include a solid matrix material that defines a plurality of fuel channels. The spherical core may include a fuel material disposed in the plurality of fuel channels. The spherical core may include one or more control rod channels, each extending from the outer periphery of the spherical core along a radius to the central portion of the spherical core. The nuclear reactor may include a reactivity control system that may have one or more control rods comprising a neutron absorbing material for insertion into the one or more control rod channels.

In some embodiments, at least one of the one or more control rods may have an inner absorber radius of 3 cm and an outer absorber radius of about 5 cm. In some embodiments, each of the one or more control rods may be about 24.5 cm in length. In some embodiments, a material of each of the one or more control rods may include one or more of boron carbide or lead. In some embodiments, each of the one or more control rods may be enclosed in a metallic case. In some embodiments, the metallic case may be 5 mm thick.

### Overall System

In some embodiments, a power generation system may include a shipping container defining an interior space. The power generation system may include a first nuclear reactor disposed in the interior space proximate one end of the container, said first nuclear reactor comprising a heat-generating fuel material and a primary medium for transferring heat generated by the fuel material to one or more first heat exchangers. The power generation system may include a second nuclear reactor disposed in the interior space proximate the other end of the container. Said second nuclear reactor may include a heat-generating fuel material and a primary medium for transferring heat generated by the fuel material to one or more second heat exchangers. The power generation system may include an electric generating system disposed in the interior space intermediate said first and second nuclear reactors. Said electric generating system may include one or more turbines driven by a fluid. Said turbine may drive fluid absorbing heat from the first and second heat exchangers before driving one or more generators.

In some embodiments, said turbine driving fluid may include air drawn from exterior to the container prior to absorbing heat from said heat exchangers, and discharged to the exterior of the shipping container after driving the one or more turbines. In some embodiments, said electric generating system may include a Brayton cycle. In some embodiments, each nuclear reactor may include a vessel having a core contained within an interior cavity defined by a wall and one or more of said heat exchangers disposed on an exterior of said wall. In some embodiments, said core may include one or more fuel elements comprising a solid matrix material defining one or more fuel channels. Said core may include a fuel material disposed in the one or more fuel channels. The solid matrix material may form said primary medium for transferring heat generated by the fuel material to said one or more first and second heat exchangers.

In some embodiments, the solid matrix material may include one or more of aluminum nitride, beryllium oxide, graphite, graphene or other carbon allotrope materials, synthetic diamond, beryllium carbide, ceramic, or silicon carbide, and wherein the fuel material comprises one or more of uranium dioxide, uranium nitride, uranium carbide, uranium silicide, or uranium metal. In some embodiments, said core and said vessel may be cylindrical. In some embodiments, a longitudinal axis of each of said core and said vessel may be oriented horizontally. In some embodiments, said core and said vessel are spherical.

In some embodiments, a power generation system may include a first nuclear reactor, which may include a vessel having a wall defining a cavity. The nuclear reactor may include a core disposed within said cavity. Said core may include a solid matrix material defining one or more channels. A fuel material may be disposed in said one or more channels.

Said solid matrix material may be a primary heat transfer medium. The power generation system may include an electric generating system having a secondary heat transfer medium. The power generation system may include one or more heat exchangers thermally coupled to said vessel wall. Said primary heat transfer medium may transfer heat generated by the fuel material to the one or more heat exchangers. Said secondary heat transfer medium may draw heat from said one or more heat exchangers.

In some embodiments, said electric generation system may include a turbine and a generator driven by said turbine. Said secondary heat transfer medium may include a fluid that drives said turbine. In some embodiments, said core may be generally cylindrical and may include a plurality of fuel elements arranged in concentric rings about a longitudinal axis of the core. Each fuel element may include a solid matrix material defining a plurality of fuel channels. Said fuel material may be disposed in the plurality of fuel channels. Said core may be generally spherical and may include a plurality of hexagonal fuel elements and a plurality of pentagonal fuel elements extending radially from an inner radius to an outer radius of the core. Each fuel element may include a solid matrix material defining a plurality of fuel channels. Said fuel material may be disposed in the plurality of fuel channels.

In some embodiments, said core may be generally cylindrical and may include a plurality of fuel elements arranged in concentric rings about a longitudinal axis of the core. Each fuel element may include a solid matrix material defining a plurality of fuel channels. Said fuel material may be disposed in the plurality of fuel channels. In some embodiments, said core may be generally spherical and may include a plurality of hexagonal fuel elements and a plurality of pentagonal fuel elements extending radially from an inner radius to an outer radius of the core. Each fuel element may include a solid matrix material defining a plurality of fuel channels. Said fuel material may be disposed in the plurality of fuel channels.

In some embodiments, the power generation system may include a heat exchanger disposed proximate an outer radius of said core. In some embodiments, the power generation system may include a heat exchanger disposed proximate an inner radius of said core. In some embodiments, the power generation system may include a shipping container defining an interior space. Said first nuclear reactor and said electric generating system may be disposed within said interior space. In some embodiments, the power generation system may include a second nuclear reactor disposed within said interior space proximate one end of said container. The first nuclear reactor may be disposed proximate the other end of said container. Said electric generating system may be disposed intermediate said first and second nuclear reactors.

In some embodiments, said electric generating system may include one or more compressors, one or more turbines, and one or more generators. Said secondary heat transfer medium may include a fluid that drives the one or more turbines. In some embodiments, the secondary heat transfer medium may include air, said air being drawn from outside said container through an air intake to at least one of said compressors, through at least one of said heat exchangers, through at least one of said turbines, and out of said container through an air discharge. In some embodiments, the electric generating system may include one or more filters coupled to the air intake. In some embodiments, the electric generating system may have a cycle efficiency of about 15-32%.

### Heat Exchangers

In some embodiments, a thermal transfer unit may include one or more modules formed from one or more heat conductive materials. One or more of said modules may include a fluid inlet portion configured to receive a thermal regulation fluid, said fluid inlet portion may include a fluid inlet surface. One or more of said modules may include a thermal interface portion configured to interface with and thermally couple to an object for temperature regulation of the object. Said thermal interface portion may include a fluid return surface. Said module may define a plurality of micro-channels extending between said fluid inlet surface and said fluid return surface. Said module may define a plurality of fluid return channels extending from said fluid return surface to an outlet. Said module may define a plurality of lateral fluid supply channels on said fluid inlet surface interconnecting at least a subset of said micro-channels. Said module may define a plurality of lateral fluid return channels on said fluid return surface interconnecting at least a subset of said micro-channels and said fluid return channels.

In some embodiments, the thermal regulation fluid may include one or more gasses. In some embodiments, the thermal regulation fluid may include air. In some embodiments, air may flow from said fluid inlet surface to an outlet in less than fifteen milliseconds. In some embodiments, air may flow from said fluid inlet surface to the outlet in less than five milliseconds. In some embodiments, the thermal transfer unit may absorb heat from a heat-generating object thermally coupled to said unit.

In some embodiments, the heat-generating object may include a nuclear reactor. In some embodiments, the nuclear reactor may include a vessel having a wall defining a cavity and a reactor core contained within the cavity. Said thermal interface portion may be thermally coupled to the vessel wall. In some embodiments, the thermal regulation fluid may be air. In some embodiments, a residence time of the air within said module may be less than fifteen milliseconds. In some embodiments, the object thermally coupled to said thermal transfer unit may absorb heat from said unit. In some embodiments, the thermal transfer unit may include an inlet/outlet manifold. Said manifold may define one or more thermal regulation fluid supply channels each having an outlet proximate said fluid inlet surface, and one or more fluid return channels fluidically isolated from said supply channels. In some embodiments, at least one of said supply channels may be coaxial with one of said return channels. In some embodiments, a surface to volume ratio of said module may be greater than four hundred square meters per cubic meter.

In some embodiments, said module may be comprised of one or more of inconel, alloy 800h-alloy 800h/at, alloy 230-uns n06230 , alloy 556-uns r30556, alloy x-uns n06002, alloy 601-alloy 601, stainless steel 347-s34709, inconel 617 uns n06617. In some embodiments, said module may be hexagonal and may define a central fluid return channel and a plurality of fluid return channels positioned in a hexagonal pattern around the central fluid return channel. In some embodiments, a plurality of said micro-channels may have a diameter of about 0.25 millimeters and may be distributed in the module with a pitch of about 0.40 millimeters. In some embodiments, the thermal transfer unit may include a plurality of hexagonal modules arranged in concentric rings. In some embodiments, said fluid return surface may be planar. In some embodiments, said fluid return surface may be curved. In some embodiments, the curvature of said fluid return surface may be spherical.

In some embodiments, a power generation system may include a heat generating system comprising a primary heat transfer medium thermally coupled to a heat transfer interface. The power generation system may include an electric generating system comprising a secondary heat transfer medium. The power generation system may include a heat transfer unit for transferring heat from said primary heat transfer medium to said secondary heat transfer medium. The heat transfer unit may include one or more modules formed from one or more heat conductive materials. One or more of said modules may include an inlet portion configured to receive said secondary heat transfer medium from one or more inlet ducts configured to deliver the secondary heat transfer medium from said electric generating system to said inlet portion of said module. Said inlet portion may include an inlet surface. One or more modules may include a thermal interface portion configured to interface with and thermally couple to said heat transfer interface of said heat generating system. Said thermal interface portion may include a return surface. Said modules may include a plurality of micro-channels extending between said inlet surface and return surface. Said modules may include a plurality of return channels, each extending from said return surface to an outlet duct. Said outlet ducts may be configured to deliver said secondary heat transfer medium to said electric generating system. Said modules may include a plurality of lateral supply channels on said inlet surface interconnecting at least a subset of said micro-channels. Said modules may include a plurality of lateral return channels on said return surface interconnecting at least a subset of said micro-channels and said return channels.

In some embodiments, said heat generating system may include a nuclear reactor having a vessel having a wall defining a cavity. Said heat transfer interface may include said wall. The nuclear reactor may include a core disposed within said cavity. Said core may include a solid matrix material defining one or more channels, and a fuel material disposed in said one or more channels. Said primary heat transfer medium may include said solid matrix material. In some embodiments, the power generation system may include a second heat generation system. The second heat generation system may include a nuclear reactor with a vessel having a wall defining a cavity. Said heat transfer interface may include said wall. The nuclear reactor may include a core disposed within said cavity. Said core may include a solid matrix material defining one or more channels, and a fuel material disposed in said one or more channels. Said primary heat transfer medium may include said solid matrix material.

In some embodiments, said electric generation system may include a turbine and a generator driven by said turbine. Said secondary heat transfer medium may include air that drives said turbine after being discharged from said one or more outlet ducts. In some embodiments, said vessel wall may be generally cylindrical. Said heat transfer interface may include at least a portion of said vessel wall forming one axial end of said cylindrical wall. Said core may be generally cylindrical and disposed coaxially within the cavity defined by said cylindrical vessel wall. Said core may include a plurality of hexagonal fuel elements arranged in concentric rings about a longitudinal axis of the core. Each fuel element may include a solid matrix material defining a plurality of fuel channels. Said fuel material may be disposed in the plurality of fuel channels. Said primary heat transfer medium may include said solid matrix material.

In some embodiments, a plurality of said modules of said heat transfer unit may be hexagonal with each of said modules being mechanically and thermally coupled to said heat transfer interface in axial alignment with one of said plurality of hexagonal fuel elements. In some embodiments, a number of hexagonal modules may correspond to a number of hexagonal fuel elements. In some embodiments, said heat transfer interface may include said vessel wall forming an other axial end of said generally cylindrical vessel wall. A plurality of said modules of said heat transfer unit may be hexagonal with each of said modules being mechanically and thermally coupled to said heat transfer interface comprising the vessel wall forming said other axial end of said cylindrical vessel wall in axial alignment with one of said plurality of hexagonal fuel elements. In some embodiments, the number of hexagonal modules mechanically and thermally coupled to said heat transfer interface comprising the vessel wall forming said other axial end of said cylindrical vessel may correspond to the number of hexagonal fuel elements. In some embodiments, a longitudinal axis of said vessel and the longitudinal axis of said core may be horizontal.

In some embodiments, the power generation system may include a second heat generation system and second heat transfer unit for transferring heat from the primary heat transfer medium of said second heat generation unit to said secondary heat transfer medium of said electric generation system. In some embodiments, said vessel wall may be generally spherical. Said heat transfer interface may include at least a portion of said vessel wall. Said core may be generally spherical and may be disposed within the cavity defined by said spherical vessel wall. Said core may include a plurality of hexagonal fuel elements and a plurality of pentagonal fuel elements extending radially from an inner radius to an outer radius of the core. Each fuel element may include a solid matrix material defining a plurality of fuel channels. Said fuel material may be disposed in the plurality of fuel channels. Said primary heat transfer medium may include said solid matrix material.

In some embodiments, a plurality of said modules of said heat transfer unit maybe hexagonal with each of said modules being mechanically and thermally coupled to said heat transfer interface in radial alignment with one of said plurality of hexagonal fuel elements. In some embodiments, a plurality of said modules of said heat transfer unit may be pentagonal with each of said modules being mechanically and thermally coupled to said heat transfer interface in radial alignment with one of said plurality of pentagonal fuel elements. In some embodiments, a number of hexagonal modules may correspond to a number of hexagonal fuel elements, and a number of pentagonal modules may correspond to a number of pentagonal fuel elements. In some embodiments, the power generation system may include a second heat generation system and second heat transfer unit for transferring heat from the primary heat transfer medium of said second heat generation unit to said secondary heat transfer medium of said electric generation system. In some embodiments, a plurality of said modules of said heat transfer unit may be pentagonal with each of said modules being mechanically and thermally coupled to said heat transfer interface in radial alignment with one of said plurality of pentagonal fuel elements. In some embodiments, said electric generation system may include a turbine and a generator driven by said turbine. Said secondary heat transfer medium may include air that drives said turbine after being discharged from said one or more outlet ducts.

In some embodiments, a thermal transfer unit may include one or more modules formed from one or more heat conductive materials having a surface to volume ratio of greater than four hundred square meters per cubic meter. One or more of said modules may include a fluid inlet portion configured to receive a thermal regulation fluid. Said fluid inlet portion may include a fluid inlet surface. One or more of said modules may include a thermal interface portion configured to interface with and thermally couple to an object for temperature regulation of the object. Said thermal interface portion may include a fluid return surface. Said module may include a matrix of pores configured to effect fluid flow from said fluid inlet surface to said fluid return surface. Said module may include a plurality of fluid return channels extending from said fluid return surface to an outlet. Said module may include a matrix of pores on or proximate said fluid inlet surface configured to effect fluid flow in a lateral direction. Said module may include a matrix of pores on or proximate said fluid return surface configured to effect fluid flow in a lateral direction.

In some embodiments, said one or more modules may include one or more metals. Said matrix of pores configured to effect fluid flow from said fluid inlet surface to said fluid return surface may include a plurality of micro-channels extending between said fluid inlet surface and said fluid return surface. Said matrix of pores on or proximate said fluid inlet surface configured to effect fluid flow in a lateral direction may include a plurality of lateral fluid supply channels on said fluid inlet surface interconnecting at least a subset of said micro-channels. Said matrix of pores on or proximate said fluid return surface configured to effect fluid flow in a lateral direction may include a plurality of lateral fluid return channels on said fluid return surface interconnecting at least a subset of said micro-channels and said fluid return channels. In some embodiments, said module may include a plurality of layers comprising ceramic foam.

In some embodiments, the thermal transfer unit includes a fluid inlet portion comprising ceramic foam having a pore density of no more than twenty pores per inch (ppi). The thermal transfer unit may include a fluid return portion comprising ceramic foam having a pore density of no more than twenty ppi. The thermal transfer unit may include an intermediate portion extending between said inlet portion and said return portion. Said intermediate portion may include one or more layers of ceramic foam having a pore density of more than twenty ppi. In some embodiments, said intermediate portion may include a pair of layers comprising a ceramic foam having a pore density of no more than forty ppi separated by a layer comprising ceramic foam having a pore density of more than forty ppi. In some embodiments, said layer of ceramic foam having a pore density of more than forty ppi may include a ceramic foam having a pore density of more than fifty ppi. In some embodiments, said inlet portion and said return portion may include ceramic foam having a pore density of no more than fifteen ppi.

In some embodiments, the thermal regulation fluid may include one or more gasses. In some embodiments, the thermal regulation fluid may include air. In some embodiments, the gaseous fluid may flow from said fluid inlet surface to an outlet in less than one hundred milliseconds. In some embodiments, the gaseous fluid may flow from said fluid inlet surface to an outlet in less than fifteen milliseconds.

In some embodiments, the thermal transfer unit may absorb heat from a heat-generating object thermally coupled to said unit. In some embodiments, the heat-generating object may include a nuclear reactor. In some embodiments, the nuclear reactor may include a vessel having a wall defining a cavity and a reactor core contained within the cavity. Said thermal interface portion may be thermally coupled to the vessel wall.

In some embodiments, the thermal transfer unit may include an inlet/outlet manifold. Said manifold may define one or more thermal regulation fluid supply channels each having an outlet proximate said fluid inlet surface, and one or more fluid return channels fluidically isolated from said supply channels. In some embodiments, at least one of said supply channels may be coaxial with one of said return channels. In some embodiments, said fluid return surface may be planar. In some embodiments, said fluid return surface may be curved. In some embodiments, a curvature of said fluid return surface may be spherical.

In some embodiments, a power generation system may include a heat generating system comprising a primary heat transfer medium thermally coupled to a heat transfer interface. The power generation system may include an electric generating system comprising a secondary heat transfer medium. The power generation system may include a heat transfer unit for transferring heat from said primary heat transfer medium to said secondary heat transfer medium. Said unit may include one or more modules having an inlet portion configured to receive said secondary heat transfer medium from one or more inlet ducts configured to deliver the secondary heat transfer medium from said electric generating system to said inlet portion of said module.

Said inlet portion may include ceramic foam having a first pore density. Said module may include a thermal interface portion configured to interface with and thermally couple to said heat transfer interface of said heat generating system. Said thermal interface portion may include ceramic foam having a second pore density. Said module may include an intermediate portion between said inlet portion and said return portion. Said intermediate portion may include ceramic foam having a pore density greater than the first and second pore densities.

In some embodiments, the first and second pore densities may be no more than twenty ppi. Said intermediate portion may include a pair of layers comprising ceramic foam having a pore density of no more than forty ppi separated by a layer comprising ceramic foam having a pore density of more than forty ppi.

In some embodiments, said heat generating system may include a nuclear reactor with a vessel having a wall defining a cavity. Said heat transfer interface may include said wall. The nuclear reactor may include a core disposed within said cavity. Said core may include a solid matrix material defining one or more channels. A fuel material may be disposed in said one or more channels. Said primary heat transfer medium may include said solid matrix material.

In some embodiments, the power generation system may include a second heat generation system. Said second heat generating system may include a nuclear reactor with a vessel having a wall defining a cavity. Said heat transfer interface may include said wall. The nuclear reactor may include a core disposed within said cavity. Said core may include a solid matrix material defining one or more channels, and a fuel material disposed in said one or more channels. Said primary heat transfer medium may include said solid matrix material. In some embodiments, said electric generation system may include a turbine and a generator driven by said turbine. Said secondary heat transfer medium may include air that drives said turbine after being discharged from one or more outlet ducts.

In some embodiments, said vessel wall may be generally cylindrical. Said heat transfer interface may include at least a portion of said vessel wall forming one axial end of said cylindrical wall. Said core may be generally cylindrical and disposed coaxially within the cavity defined by said cylindrical vessel wall. Said core may include a plurality of hexagonal fuel elements arranged in concentric rings about a longitudinal axis of the core. Each fuel element may include a solid matrix material defining a plurality of fuel channels. Said fuel material may be disposed in the plurality of fuel channels. Said primary heat transfer medium may include said solid matrix material.

In some embodiments, a plurality of said modules of said heat transfer unit may be hexagonal with each of said modules being mechanically and thermally coupled to said heat transfer interface in axial alignment with one of said plurality of hexagonal fuel elements. In some embodiments, a number of hexagonal modules may correspond to a number of hexagonal fuel elements. In some embodiments, said heat transfer interface may include said vessel wall forming another axial end of said generally cylindrical vessel wall. A plurality of said modules of said heat transfer unit may be hexagonal with each of said modules being mechanically and thermally coupled to said heat transfer interface comprising the vessel wall forming said other axial end of said cylindrical vessel wall in axial alignment with one of said plurality of hexagonal fuel elements. In some embodiments, a number of hexagonal modules mechanically and thermally coupled to said heat transfer interface comprising the vessel wall forming said other axial end of said cylindrical vessel may correspond to a number of hexagonal fuel elements. In some embodiments, a longitudinal axis of said vessel and a longitudinal axis of said core may be horizontal.

In some embodiments, the power generation system may include a second heat generation system and second heat transfer unit for transferring heat from the primary heat transfer medium of said second heat generation unit to said secondary heat transfer medium of said electric generation system. In some embodiments, said vessel wall may be generally spherical. Said heat transfer interface may include at least a portion of said vessel wall. Said core may be generally spherical and may be disposed within the cavity defined by said spherical vessel wall. Said core may include a plurality of hexagonal fuel elements and a plurality of pentagonal fuel elements extending radially from an inner radius to an outer radius of the core. Each fuel element may include a solid matrix material defining a plurality of fuel channels. Said fuel material may be disposed in the plurality of fuel channels. Said primary heat transfer medium may include said solid matrix material.

In some embodiments, a plurality of said modules of said heat transfer unit may be hexagonal with each of said modules being mechanically and thermally coupled to said heat transfer interface in radial alignment with one of said plurality of hexagonal fuel elements. In some embodiments, a plurality of said modules of said heat transfer unit may be pentagonal with each of said modules being mechanically and thermally coupled to said heat transfer interface in radial alignment with one of said plurality of pentagonal fuel elements. In some embodiments, a number of hexagonal modules may correspond to a number of hexagonal fuel elements, and a number of pentagonal modules may correspond to a number of pentagonal fuel elements. In some embodiments, the power generation system may include a second heat generation system and second heat transfer unit for transferring heat from the primary heat transfer medium of said second heat generation unit to said secondary heat transfer medium of said electric generation system.

It may be emphasized that the above-described embodiments, particularly any “preferred” embodiments, are merely possible examples of implementations, set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

While this specification contains many specifics, these should not be construed as limitations on the scope of any disclosures, but rather as descriptions of features that may be specific to a particular embodiment. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A power generation system comprising:
a shipping container defining an interior space;
a first nuclear reactor disposed in the interior space proximate one end of the container, said first nuclear reactor comprising a heat-generating fuel material and a primary medium for transferring heat generated by the fuel material to one or more first heat exchangers;
a second nuclear reactor disposed in the interior space proximate the other end of the container, said second nuclear reactor comprising a heat-generating fuel material and a primary medium for transferring heat generated by the fuel material to one or more second heat exchangers;
an electric generating system disposed in the interior space intermediate said first and second nuclear reactors, said electric generating system comprising one or more turbines driven by a fluid, said turbine driving fluid absorbing heat from the first and second heat exchangers before driving one or more generators.

2. The power generation system of claim 1, wherein said turbine driving fluid comprises air drawn from exterior to the container prior to absorbing heat from said heat exchangers, and discharged to the exterior of the shipping container after driving the one or more turbines.

3. The power generation system of claim 2, wherein said electric generating system comprises a Brayton cycle.

4. The power generation system of claim 1, wherein each nuclear reactor comprises a vessel having a core contained within an interior cavity defined by a wall and one or more of said heat exchangers disposed on an exterior of said wall.

5. The power generation system of claim 4, wherein said core comprises one or more fuel elements comprising a solid matrix material defining one or more fuel channels; and
a fuel material disposed in the one or more fuel channels,
wherein the solid matrix material forms said primary medium for transferring heat generated by the fuel material to said one or more first and second heat exchangers.

6. The power generation system of claim 5, wherein the solid matrix material comprises one or more of aluminum nitride, beryllium oxide, graphite, graphene or other carbon allotrope materials, synthetic diamond, beryllium carbide, ceramic, or silicon carbide, and wherein the fuel material comprises one or more of uranium dioxide, uranium nitride, uranium carbide, uranium silicide, or uranium metal.

7. The power generation system of claim 6, wherein said core and said vessel are cylindrical.

8. The power generation system of claim 7, wherein a longitudinal axis of each of said core and said vessel is oriented horizontally.

9. The power generation system of claim 7, wherein said core and said vessel are spherical.

10. A power generation system comprising:
a first nuclear reactor comprising:
a vessel having a wall defining a cavity;
a core disposed within said cavity, said core comprising a solid matrix material defining one or more channels, and a fuel material disposed in said one or more channels, said solid matrix material comprising a primary heat transfer medium;
an electric generating system comprising a secondary heat transfer medium; and
one or more heat exchangers thermally coupled to said vessel wall;
wherein said primary heat transfer medium transfers heat generated by the fuel material to the one or more heat exchangers, and
wherein said secondary heat transfer medium draws heat from said one or more heat exchangers.

11. The power generation system of claim 10, wherein said electric generation system comprises a turbine and a generator driven by said turbine, wherein said secondary heat transfer medium comprises a fluid that drives said turbine.

12. The power generation system of claim 11, wherein said core is generally cylindrical and comprises a plurality of fuel elements arranged in concentric rings about a longitudinal axis of the core, each fuel element comprising a solid matrix material defining a plurality of fuel channels, and said fuel material disposed in the plurality of fuel channels.

13. The power generation system of claim 11, wherein said core is generally spherical and comprises a plurality of hexagonal fuel elements and a plurality of pentagonal fuel elements extending radially from an inner radius to an outer radius of the core, each fuel element comprising a solid matrix material defining a plurality of fuel channels, and said fuel material disposed in the plurality of fuel channels.

14. The power generation system of claim 10, wherein said core is generally cylindrical and comprises a plurality of fuel elements arranged in concentric rings about a longitudinal axis of the core, each fuel element comprising a solid matrix material defining a plurality of fuel channels, and said fuel material disposed in the plurality of fuel channels.

15. The power generation system of claim 10, wherein said core is generally spherical and comprises a plurality of hexagonal fuel elements and a plurality of pentagonal fuel elements extending radially from an inner radius to an outer radius of the core, each fuel element comprising a solid matrix material defining a plurality of fuel channels, and said fuel material disposed in the plurality of fuel channels.

16. The power generation system of claim 15, further comprising a heat exchanger disposed proximate an outer radius of said core.

17. The power generation system of claim 16, further comprising a heat exchanger disposed proximate an inner radius of said core.

18. The power generation system of claim 10, further comprising a shipping container defining an interior space, wherein said first nuclear reactor and said electric generating system are disposed within said interior space.

19. The power generation system of claim 18, further comprising a second nuclear reactor disposed within said interior space proximate one end of said container, the first nuclear reactor disposed proximate the other end of said container, and said electric generating system disposed intermediate said first and second nuclear reactors.

20. The power generation system of claim 19, wherein said electric generating system comprises:
one or more compressors;
one or more turbines; and
one or more generators,
wherein said secondary heat transfer medium comprises a fluid that drives the one or more turbines.

21. The power generation system of claim 20, wherein the secondary heat transfer medium comprises air, said air being drawn from outside said container through an air intake to at least one of said compressors, through at least one of said heat exchangers, through at least one of said turbines, and out of said container through an air discharge.

22. The power generation system of claim 21, wherein the electric generating system further comprises one or more filters coupled to the air intake.

23. The power generation system of claim 21, wherein the electric generating system has a cycle efficiency of about 15-32%.
